(19) United States
(12) Patent Application Publication
(10) Pub. No.: US 2004/0039706 A1
(43) Pub. Date: Feb. 26, 2004

(54) System and method for digitally authenticating facility management reports

(76) Inventors: John M. Skowron, Lindenhurst, IL (US); Nellie Martin, Deerfield, IL (US)

Correspondence Address: Siemens Corporation, Intellectual Property Department, 170 Wood Avenue South, Iselin, NJ, 08830, US

(21) Appl. No.: 10/465,150

(22) Filed: Jun. 19, 2003

Related U.S. Application Data
(60) Provisional application No. 60/389,823, filed on Jun. 19, 2002.

(51) Int. Cl. H04K 1/00; H04L 9/00; G06F 17/60

(52) U.S. Cl. 705/51

(57) ABSTRACT

An apparatus and method for generating and digitally authorizing a report indicating the performance conditions of a facility are provided. The apparatus and method are intended for use in allowing facility managers to document the performance of their facilities. The present invention allows a user to generate a PDF report indicating the status of facility that can be digitally authenticated by the user. Any attempted modifications of a digitally authenticated report are documented so that the accuracy of the report can be verified.

This application claims the benefit of U.S. Provisional Patent Application Serial No. 60/389,823, filed Jun. 19, 2002, and which is incorporated herein by reference.

### BACKGROUND OF THE INVENTION

The present invention relates, in general, to the digital authorization of reports generated describing the performance of points in a facility management system. The present invention is related to U.S. patent application 2003/0078880 A1, which is incorporated by reference herein.

There is a need in many different types of facilities to be able to document the conditions within the facility over a certain period of time. For example, users within FDA regulated pharmaceutical markets expect document reporting systems to meet the requirements of the FDA's CFR part 11 and requirements for electronic submissions. For example, pharmaceutical manufacturers may be required to document in reports that the temperature and humidity within a manufacturing facility were within certain ranges during a production run. As a result, there is currently a need for a system and method that can produce reports from data collected from a facility management system in a PDF format that allows the user to electronically sign it to ensure that a record cannot be readily repudiated as genuine.

### SUMMARY OF THE INVENTION

In one exemplary embodiment, the process of generating a signed PDF document starts by creating a report template that contains various tables, charts, and other objects. These objects contain information about points in a facility management system. These points have date/time data associated with them. A report can be then be generated when a time frame is specified. A server then generates a report with point data in it and converts it into a PDF document. The user can then view with report and electronically sign it. Once it is signed, then it can't be changed without another signature. This signed report can then be used as an official FDA document.

### BRIEF DESCRIPTION OF THE DRAWINGS

While the specification concludes with claims particularly pointing out and distinctly claiming the invention, it is believed that the same will be better understood from the following description taken in conjunction with the accompanying drawings in which:

FIG. 1 is a schematic diagram of an exemplary facility management system in which the present invention is implemented;

FIG. 2 is a schematic diagram showing the present invention;

FIG. 3 is an illustration of a report generated using the present invention;

FIG. 4 is an illustration of a template according to the present invention;

FIG. 5 is an illustration of a table according to the present invention;

FIG. 6 is a flow chart representing an embodiment of the method of the invention;

FIG. 7 is a flow chart representing an embodiment of the method of the invention;

FIGS. 8-14 illustrate exemplary user interfaces that may be displayed on the user interface of a client of the present invention;

FIG. 15 is a flow chart representing an embodiment of the method of the invention;

FIGS. 16-31 illustrate user interfaces that may be presented to a user of a client of the present invention; and

FIG. 32 is a flow chart representing an embodiment of the method of the invention.

### DETAILED DESCRIPTION OF EXEMPLARY EMBODIMENTS

The present invention is a multi-functional, information management platform designed to meet the needs of users who wish to add value to their facility automation systems by turning data into valuable information. Whether users are interested in energy management and cost allocation, animal facility reporting or compliance with regulatory guidelines, the present invention can be specifically tailored to meet those needs.

In order to comply with regulatory compliance requirements of government agencies such as the Food and Drug Administration, (FDA), facilities, such as pharmaceutical manufacturers, must maintain energy management, environmental control, monitoring and long term trend data. The present invention uses client server architecture and web enabling software, in conjunction with a building automation system such as an APOGEE® building control system, to allow multiple users the ability to access real time facility performance data, alarms, command points as well as access trend data stored in a central database server across an Ethernet network. Point trend data generated by the building automation system is imported into the server database via automatic file transfer over an Ethernet network. Using the present invention, such facility performance data may be stored in reports that may be digitally authenticated to allow the user to comply with governmental agencies such as the FDA and EPA.

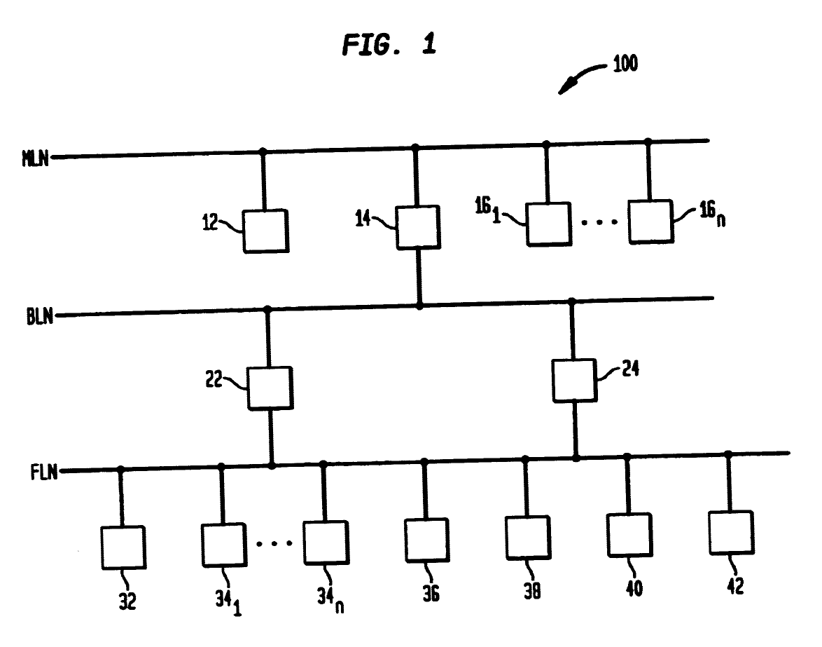

In FIG. 1 is illustrated an exemplary system for implementing the teachings of the present invention. The network architecture of the facility management system 5 of the present invention is preferably comprised of three levels, a management level network (MLN) 10, which is an Ethernet network based on TCP/IP protocol, a building level network (BLN) 20, and a floor level network (FLN) 30. Connected to the MLN 10 is a report server 12, an building automation server 14, such as an APOGEE® building control system, and at least one building automation client 16₁-16ₙ. Server 14 provides overall control of the facility management system 5 and includes a user interface. The MLN 10 may also suitably employ BACnet, XML and/or other protocols that support high speed data communications. The MLN 10 may connect to other supervisory computers, Internet gateways, or other gateways to other external devices, as well as additional network managers (which in turn connect to more subsystems via additional low level data networks). While FIG. 1. shows a report server 12 and a building automation server 14, one server capable of providing the functions of servers 12 and 14 may be sufficient to meet the requirements of the present invention.

The BLN 20 is comprised of at least one peer-to-peer modular building controller (MBC) 22 and at least one modular equipment controller (MEC) 24. MBC 22 is a modular, programmable primary controller with a supervisory interface capability to monitor a secondary controller network. The MBC 24 is designed to control general HVAC applications including air-handling units, chillers/boiler/central plant control and distribution systems, data acquisition, and other multi-equipment applications. The MBC 24 provides on-board control of I/O points and central monitoring for distributed secondary control units and other building systems (e.g. fire/life safety, security, and lighting). Each MBC 24 may control up to 96 floor level devices. Comprehensive alarm management, historical trend collection, operator control and monitoring functions are integral to the MEC 22.

Controllers 22, 24, residing on the peer to peer building level network 20, are connected to the Ethernet network without the use of a PC or a gateway with a hard drive. Any PC on the MLN 10 will have transparent communication with controllers 22 and 24 on the building level network 20 connected via Ethernet, as well as, directly connected building level networks.

Floor level devices connected to the FLN 30 may include terminal equipment controllers 32, one or more sensors 34, differential pressure monitors 36, fume hood control monitors 38, lab room controllers, digital energy monitors 40, variable frequency drives 42 and other devices such as field panels. The FLN 30 may suitably employ the standardized LonTalk protocol. Controller 22 or controller 24 serve to coordinate the communication of data and control signals between the elements on the FLN 32, 34, 36, 38, 40, 42 and the servers 12 and 14.

One desirable application of the present invention is to support organizations that are regulated by the Food and Drug Administration (FDA) in complying with its rules for electronic records and electronic signatures. The goal of the rule is to encourage the widest possible use of electronic technology to speed the review and approval of documents submitted to or audited by the FDA. The present invention will support the electronic record requirements of the rule. This is achieved through the server software of the present invention. The server 14 of the present invention is designed to automatically collect data from multiple data providers, securely store that information in a relational database system which may be provided in server 12 or 14 and track all modifications and annotations to data using an advanced audit trail system. A report manager located on a client 16 allows users to query this database in an effective manner to review data, find modification or highlight exceptions in the records. With the use of the Windows operating system with integrated security, users are assured secure access to all data records.

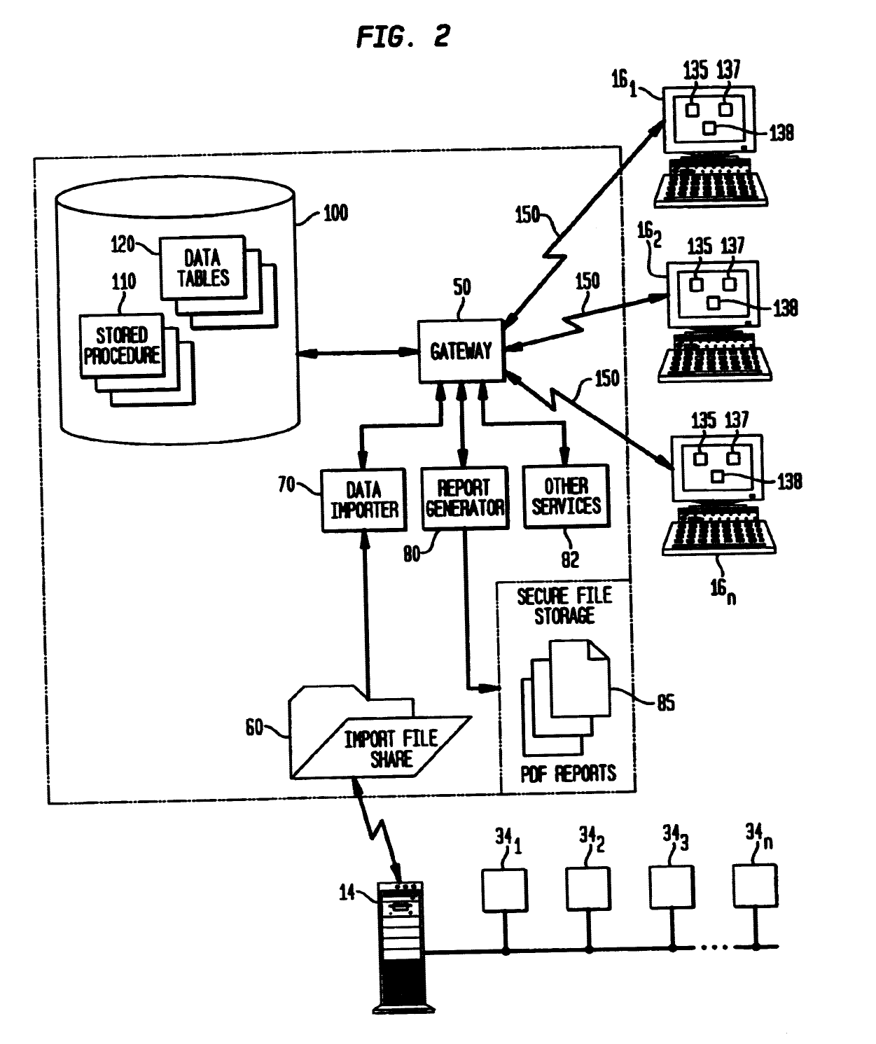

FIG. 2 further illustrates the system for implementing the teachings of the present invention. As shown in FIG. 2, report server 12 is comprised of gateway 50. Gateway 50 manages server services such as data importing through data importer 70, report generation through report generator 80, as well as other services 82. Such services may include data exporting, data archiving and data purging. Such services may also include scheduled report printing. As part of scheduled reporting, a report can be sent to a print local to server 12 or somewhere in facility management system 5. Another service may include calculating summary point values. Summary points are points that take regular points to calculate other values, like minimum, maximum, averages, sums and formulas. All of these services are done on a scheduled basis. A user may establish a schedule for each of these services with the exception of summary point services. Summary point calculations can be done on a daily basis.

Report server 12 further comprises database 100, such as an SQL relational database. In an alternative embodiment, database 100 may be an object-oriented database. Database 100 is comprised of code modules 110 such as stored procedures and schedules 120 are stored in database 100 along with report template layouts and point data. Code modules 110 are executed when needed by clients 16₁-16ₙ and services such as report generator 80 to retrieve formatted data. Schedules 120 are entries in a database table that are used to execute code modules 110 or start services based on dates and times. Code is provided in the database 100 that executes certain commands at certain times based on schedules or based upon trend events that trigger the creation of reports.

Clients 16₁-16ₙ are connected to gateway 50 through network connection 150. Clients 16₁-16ₙ are provided with report manager 135 and adobe acrobat software 137, in a preferred embodiment, to generate reports and to digitally authenticate such reports. Clients 16₁-16ₙ are further provided with a user interface 138. Report generator 80 is connected to gateway 50 and is provided to generate reports. Report generator 80 generates reports that report manager 135 of client 16 defines and is later able to open and view. Reports created by report generator 80 may be stored in file storage 85. Such reports may be created in a PDF or HTML format, depending upon the needs of the user.

As shown in FIG. 2, server 14 is operatively connected to gateway 50 of server 12 through file share 60 and data importer 70. Connected to server 14 is a plurality of points such as element 34. A point such as element 34 is a representation of a piece of hardware, a sensor on a fume hood for example, collecting information. Over period of time information from different points are generated. For example, the server 14 may send information retrieved from a sensor 34 every fifteen minutes to be stored in database 100 through gateway 50. Such information includes, but is not limited to historical data, error data, trend data and other logged events from points such as sensor 34₁-34ₙ. While FIG. 2Reports can then be based on point values stored in database 100.

Gateway 50 provides communication between clients 16₁-16ₙ and the database 100 over a network connection 150. The gateway 50 handles securities, number of connections, and includes start procedures that are interfaced with the gateway commands can be run on a client 16. Commands from gateway 50 will execute for example points commands being stored in database 100. This will allow a client 16, for example, to see what the monthly summary is for a particular point such as sensor 34 for example. A client report manager 135 will connect to gateway 50 through network connection 150, allowing client 16 to retrieve information about one or more points for a given period of time from database 100 so that the client 16 can prepare a report based upon information stored in database 100 about one or more points.

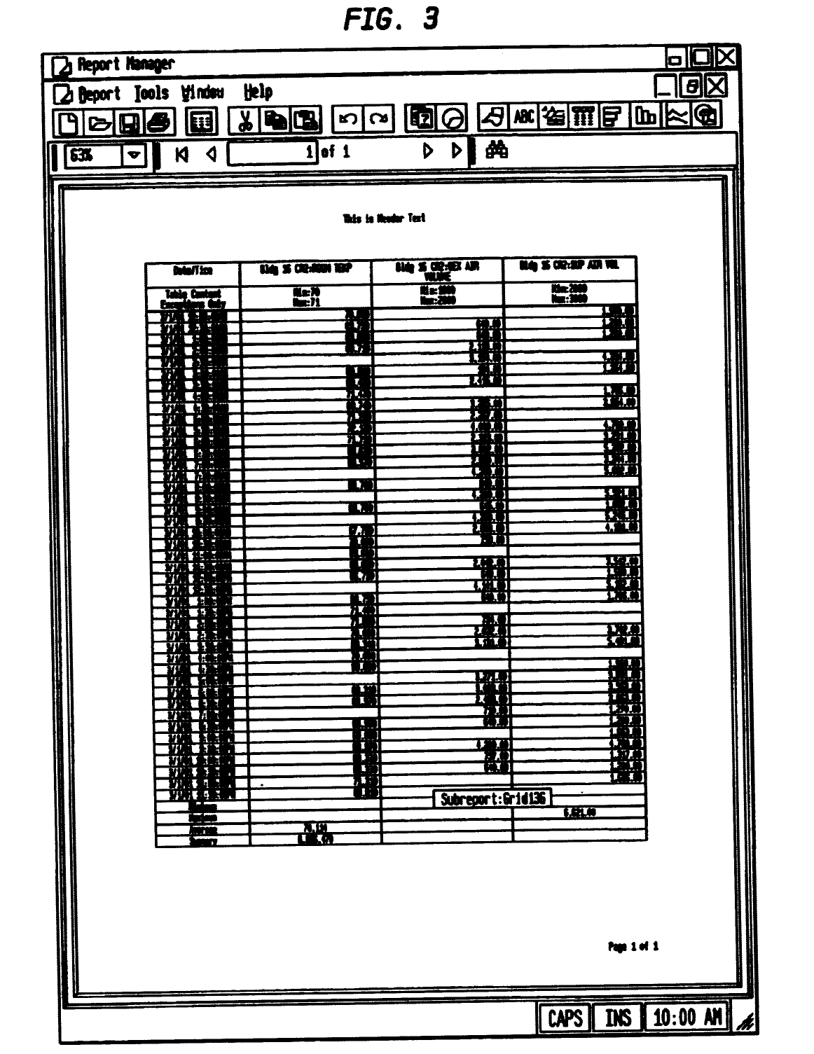

Most reports generated by the present invention are based on time relative to, for example, the temperature at a certain date and time of a region the client 16 wants to know about. As shown in FIG. 3, reports are comprised of information about a plurality of points. Reports are stored somewhere on the server 12 in a secure folder once generated. On demand reports are not stored on the server 12. Scheduled reports are saved in a directory structure on the server 12 that is really only understood by the server 12. If the client 16 wants to access one of the reports it can view it on the client 16. When the client 16 opens a report, say a PDF report, the report displayed on client 16 represents a report stored on server 12 in file storage 85. Clients 16₁-16ₙ are provided with digital authentication software 137 such as Adobe Acrobat allowing a user to digitally authenticate a report and to detect modifications to an authenticated report. Accordingly, using the present invention, a report stored on server 12 may be signed by a user using a client 16 and the report can be stored on the server 12 for future reference or submittal to the FDA.

Turning now to a generalized discussion of the present invention, a difference between records in a report and records in the server is that all trend data records are initially stored in on the server 12. This data is stored indefinitely and all audit trails are included with the records. Data that is stored in database 100 may be moved to an offline archive media that can at a later time be mounted to retrieve the archived data. This system can support the electronic records requirements of many regulatory agencies. A report is a custom formatted copy of these data records for a particular date range that is stored in a secure area of the server. Any records that contain an audit trail for changes and annotations to records are indicated with an “*” on reports.

A user can make notes about annotations on reports on client 16 when viewing a report by using the note feature to add comments. The note feature appends the user ID to the note for reference. Annotations are not necessary done on a report, but in a client 16 that may be an administrative client. The report may only indicate that there is an annotation for a point value. This is particularly useful when explaining a change or note to a record. (i.e., where an asterisk appears in a report).

Electronic records can be database records or the reports. This depends upon the user. Reports can simply be used as a method for producing human readable hardcopies of the electronic records in the database. Reports can also be used as the final electronic record. If using digital signatures, reports will need to be the electronic record because PDF based reports are preferably used since this is the format required by the FDA and it is the most secure format that can support digital signatures.

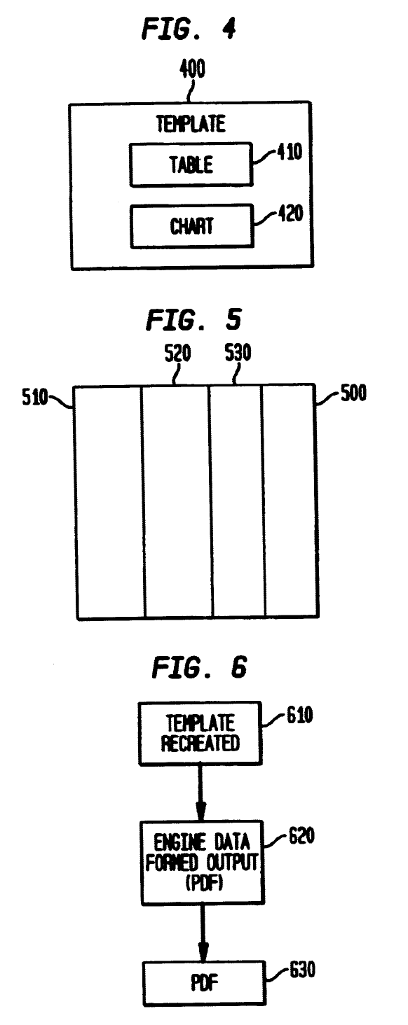

Turning now to scheduled reports, a client 16 may create schedules. A schedule will include information such as time range for data in a report, also contains format data is stored in, when report is supposed to be run, and miscellaneous information such as whether or not a report will be printed, which template is being used, and whether or not the last time the schedule was run the run was successful or not. As shown in FIG. 4, template 400 is a temporary representation of the format of the report. A template tells what objects are contained within it such as tables 410 or charts 420 or pictures. Templates are created at the client 16 and stored on the database 100. The template will have a series of objects in it. Objects can be tables, charts i.e. things that hold data. Other objects in the template may be visual, pictures, dates/times, when the report was run, and data ranges. This information is stored in the server database 100 as properties. A template is recreated when report opened or run or redesigned. Properties include tables, with subproperties including point1,point2, width, height, information about a point.

As shown in FIG. 5, templates 510, objects 520 and properties 530 are stored together like a table 500 in database 100. Template 510, object 520 and properties 530 all stored in a table 500 so that when the template 510 is opened later modifications or the server 50 decides to generate the report, it reopens the template 510 and recreates it every time based upon the properties and everything else, the location of the objects on the report, its dimensions and what it has in it, and that's all stored in the database as formatting. Report templates 410 represent the format of what is contained on a report. When a report is run, the format is used to layout the resulting data. For example, with respect to a template with a table on it, points are chosen for the table, the table's width may be provided, and other information may be used to layout the table on the report. When the report is run, all the data is filled in the report based upon the format. The point names may be provided at the top of the report, with all the point data provided below, chronologically. For a chart, a picture may be generated to represent the data placed on the report in the location specified in the design template.

Referring now to FIG. 6, as shown in step 610, when a schedule 120 comes up, and a report needs to be generated, a template is created. As shown in step 620, the template is then provided to the report generator 80 along with point data from database 100 and the intended output form of the report, such as HTML or PDF. The report generator 80 provides software libraries used to generate reports based upon the template layout. As shown in step 630, the engine will take information provided to it to create an output, which is preferably a PDF document. The output is then stored in file storage 85 of the server 12. Accordingly, when a schedule on the server 12 finds when it is supposed to run, the schedule creates a template, the schedule is transmitted to the report generator 80 and the report generator 80 generates a report, preferably in PDF format. After a PDF report has been produced using report manager 135, the generated report can be opened using report manager 135. Report manager can then simply can an associated application such as adobe acrobat to open the PDF document. Digital authorization software will then provide a mechanism for allowing the user to digitally sign the document.

The way the present invention stores reports is relative to clients 16 and schedules 120. Each client 16 will have their own schedules 120 that can't be used by other users, and when schedules 120 are run they are save in a location that is specific to the user and the schedule. Schedules 120 are preferably saved in a unique folder which is the date timestamp when the schedule is actually run. When a client 16 goes to view a list of reports based upon schedule, client 16 will display a list of reports run based upon date and time. Reports may be retrieved based upon the date they were run allowing reports which are stored in memory of server 12 to be displayed on client 16. A copy of the report may be saved on client 16 or may be saved on server 12. The client may then use the report in a format such as HTML or any other user type. Organizations such as the FDA prefer PDF since it is a secure format that cannot be easily altered and looks exactly like it will be printed. Formats such as HTML sometimes require reformatting before the document can be printed. There are some software applications that can modify PDF, but the actual data in the report such as text or information cannot be modified. Any modifications to text or information may be detected using digital signature software after the report has first been signed.

Turning now to the digital authentication of reports once created, a digital signature, like a conventional handwritten signature, identifies who is signing a document. However, unlike traditional signatures, each digital signature stores information about the signature and the status of the report when it was signed. This allows users to ensure that the signature is authentic and that the report that was signed is the one that is being reviewed. A digital signature can have any one of several formats. These include a handwritten name, a logo or other graphic, or simply text explaining the purpose of the signing. Before users can digitally sign a document for the first time, a user may have to go through an administrative process to setup an electronic signature and certification files with a system administrator. This process is similar to the creation of ID badges at a central badging station. This process is designed to ensure that a user's signature is valid, created by the proper owner and that it can be validated as authentic at a later stage. If this system is being used in accordance with the FDA's 21 CFR Part 11 rule for electronic signatures, this part of the process also allows the administrator to submit, as required, the proper paperwork to the FDA's regional operations offices to ensure the validity and legality of your signature.

The digital signatures feature in the present invention offers much more than the ability to “sign” documents to indicate that it has been read and approved. The digital authorization process of the present invention is a process designed to allow users to support all their facility digital authorization needs. The present invention will allow users to digitally insert a signature into a report to show approval or review, digitally sign a report to ensure that any modification attempts to the report are recorded. If any attempts to change the report are made after it is signed, reviewers can roll back to recover the version that was originally signed. Users of the present invention will be able to verify a digital signature to ensure that the signature is authentic. The present invention will allow users to sign reports with a digital signature that contains the printed name of the signer, the date and time the signature was executed and the meaning of the signature. The present invention will provide clear electronic displays and printouts of reports, will manage electronic signature certificates such that they are unique to one individual and cannot be reused or reassigned to anyone else. The present invention limits access to electronic signatures and certificates using three distinct components including username, and two levels of passwords. The present invention will ensure that an authorized electronic signature can only be used by its true owner, and that any breach of this security will require the collaboration of two or more individuals. The present invention will further ensure that individuals will have a unique combination of user ID and password. The present invention will provide administrative functions to check, recall the revise passwords, and will provide logging to detect and report any attempts to access secure signature files.

The report manager of server 12 of the present invention has a significantly enhanced reporting engine that allows users to select additional report output formats and report output locations. One of these report output formats is the Portable Document Format (PDF). PDF is of particular benefit to supporting regulatory requirements such as 21 CFR Part 11 because it supports digital signatures, has widespread acceptance and is the recommended format for electronic submissions to the FDA.

A key enhancement included in Information management platform is the automated association of the present inventions report viewing engine to the local desktop applications that supports a particular report format (PDF, HTML). When a user requests a scheduled report to be viewed, the report is displayed in a native application, which is associated to that reports type on a user's computer. For web page reports, this could be Internet Explorer® or Netscape®. For PDF files, it could be Adobe Acrobat or Acrobat Reader®. Users planning to include digital authorization on their reports or view reports that have been signed will be required to generate reports in a PDF format and have Adobe Acrobat or similar software installed on the client PC. Preferably, Adobe Acrobat 5.0 or higher will be used with the present invention

The digital signature feature of this solution uses Adobe Acrobat to support the ability to add, verify and manage signatures using commands and tools in the Acrobat interface. The types of signature handler plug-in that a user selects to use determines the nature of the signatures. The signature handler plug-in controls the signature appearance on the page, the exact information stored in signature certificates, and the attributes and method used for their verification. The flexibility of this structure allows users to use whichever signing method a company or regulations require, with Acrobat and the information management platform of the present invention providing a consistent and convenient front end.

Acrobat Self-Sign® Security, the default Acrobat signature handler, provides a quick and easy method of signing documents using a private/public key (PPK) system to verify the authenticity of signatures and the integrity of signed document versions. In Acrobat Self-Sign Security, each signature is associated with a profile that contains unique security data—a private key and a public key. The private key is a password-protected numerical value that allows the user to sign a document. The public key is embedded in the digital signature and is used to mathematically verify digital signatures when the signatures are verified. The private key encrypts a checksum that is stored with a signature when you sign; the public key decrypts the checksum when you verify. By properly controlling access to each private key and public key, your signature process can remain secure and in compliance with most regulatory requirements.

The signature handler has several useful attributes. Using the present invention, users may insert signatures into reports. Using proper signature administration, users can access secure, personalized digital signature profiles and place a range of signatures for various purposes on a report. Using the present invention, users may also verify signatures. Using the proper signature administration, an approved individual will have access to each signer's unique digital certificate. When this signature is applied to a report with an electronic signature, the authenticity and integrity of the signature can be confirmed.

The present invention allows users to track report changes. Once a report is signed, any changes made since the signing are recorded in the Adobe signatures palette. The user can track changes made between signings using the Signatures palette or by comparing signed versions of the document. The present invention further provides for the comparing of report versions. A user can easily see changes made between two signed versions of a report using a Compare Two Versions Within a Signed Document command. Acrobat will display the pages of the document side-by-side and highlight the differences between the two documents and the document will clearly state it has been altered since signed.

Windows security is one important aspect of the present invention's platform security. It is the key mechanism used to manage the report server 12 access, report access and user privileges. The use of Windows integrated security supports efficient management of user accounts and passwords and does not require additional, proprietary security settings. With the addition of a digital signature plug-in, recommended NTFS security settings and automated system auditing, users can combine the information management platform of the present invention, Adobe Acrobat and Windows networking to create an enterprise wide solution that meets regulatory requirements for electronic records and signatures.

The present invention provides restricted access to PDF reports. Access to PDF-based reports is restricted to individuals who are authorized to view them. Each report is securely stored on the report server 12. The present invention further provides restricted access to report manager 135. Windows-based user groups control access to the report manager 135. Users not assigned to run the report manager cannot access the application. The present invention further provides restricted access to data and report templates. Access to report templates and point data is granted on a user-by-user basis. This means, if users have access to information, it has been explicitly given to them.

Windows security is also used by this solution to provide restricted access to Digital Certificates. Access to certificates is controlled using Windows security and NTFS formatted disk media. Windows security also provides for Windows auditing. Access to digital certificates is recorded using proper Windows event auditing and recorded in the Windows security logs.

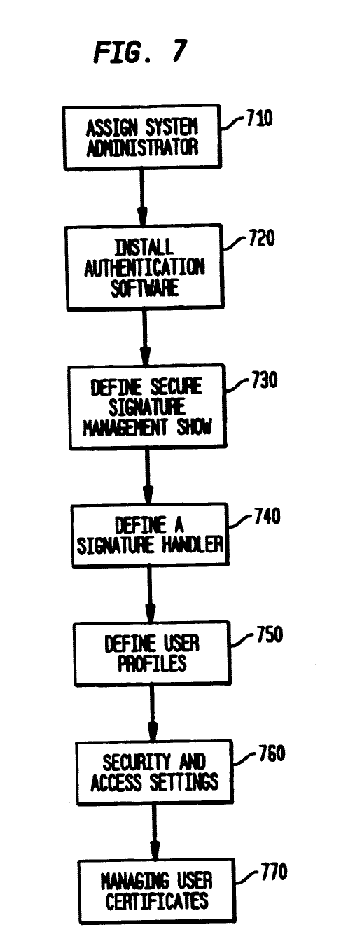

Referring to FIG. 7, a user, or a group of users, must go through a certain process if they wish to have the ability to digitally authenticate a report. In step 710, a system administrator should be assigned. The first step to implementing a successful solution is assigning roles and responsibilities along with a standard operating procedure for all users. Whether the solution is local system a closed system or an enterprise wide system, a system administrator will be preferably defined. The system administrator is responsible for managing user accounts, granting/revoking system access, and managing digital signature certificates.

In step 720, the digital authentication software must be installed. To install an information management platform solution, a system administrator should follow the installations instructions included with the software. After the server software is installed, the system administrator should grant themselves Administrator rights in the Windows user group name IM_Administrator. No other users should be granted access at this time. If this is an upgrade to an existing system, all user rights other than the system administrator should be temporarily suspended. The report manager 135 should be installed on all client computers 16 that will be used to access server 12 and create, run and view reports. If reports are created in web page format (HTML), users will preferably have Internet Explorer 5.5 or greater installed on their PC. If users are going to view PDF report formats, they preferably will have Adobe Acrobat installed on their client 16. If users are viewing/signing PDF reports with digital signatures, they will preferably have Adobe Acrobat 5.0 installed on their client 16.

In step 730, a secure signature management share should be defined. The use of digital signatures is as much a process as it is a software function. To ensure that digital signature practices comply with requirements, users must first set up, follow and maintain a process for managing signature certificates and system access.

In step 740, a signature handler should be defined. After the secure signature share is setup with folders for each user, users can create their signature profiles. This can be done at a centralized signatures station or remotely through the share setup above. The goal is to ensure that the person a signature profile represents actually creates the signature files. The following process is designed to support this need in an efficient manner. Each client PC using/viewing signatures will preferably include Adobe Acrobat 5.0 or higher. A user can begin to set a default signature handler by starting Adobe Acrobat. On each client PC the user should set the default signature handler in the Digital Signatures Preference dialog box. The user should then Choose Edit>Preferences>General and then click Digital Signatures in the left pane of the Preferences dialog box. The user may then choose the default signature handler. The pop-up menu lists all handlers installed in your Acrobat Plug-ins folder (the default is Acrobat Self-Sign Security). The user can then select verify signatures when document is opened to determine if signatures will be verified automatically when a document is opened.

In step 750, user profiles may then be defined. The user profile is the mechanism to store digital signatures information. A profile file stores the private key (encrypted), public key (wrapped in a certificate), a list of trusted certificates (certificates of other users) and other signature properties. This information is configured by the end user and stored in a centralized, controlled environment. A user can have multiple profiles for different purposes. An example might be a full signature, initials or an abbreviated signature. It is very important that the creation of this profile is done in a manner that insures that the profile belongs to the proper person, and that is cannot be used by others or manipulated by the user in the future. To ensure these needs are met, the user profiles are stored in the centralized, secure signature share defined earlier.

The signature share is designed so that only a system administrator and the actual client user have access to his specific directory in the share. Initially this will allow a user to create their signature profile and save them in this shared, secure directory. By using Windows security, the administrator is assured that only the individuals with proper access rights can deposit a signature profile and certificate into the share. Once profiles are put into the share, an administrator can review them to see they are correct and then remove write access from the share for the user.

An alternative to this remote method is to have users and the administrator perform these functions at a central PC prior to setting up client application on the end users desktop. This later method is likely easier to validate and is similar to a security badging process in which users go to have a picture taken and a badge is produced.

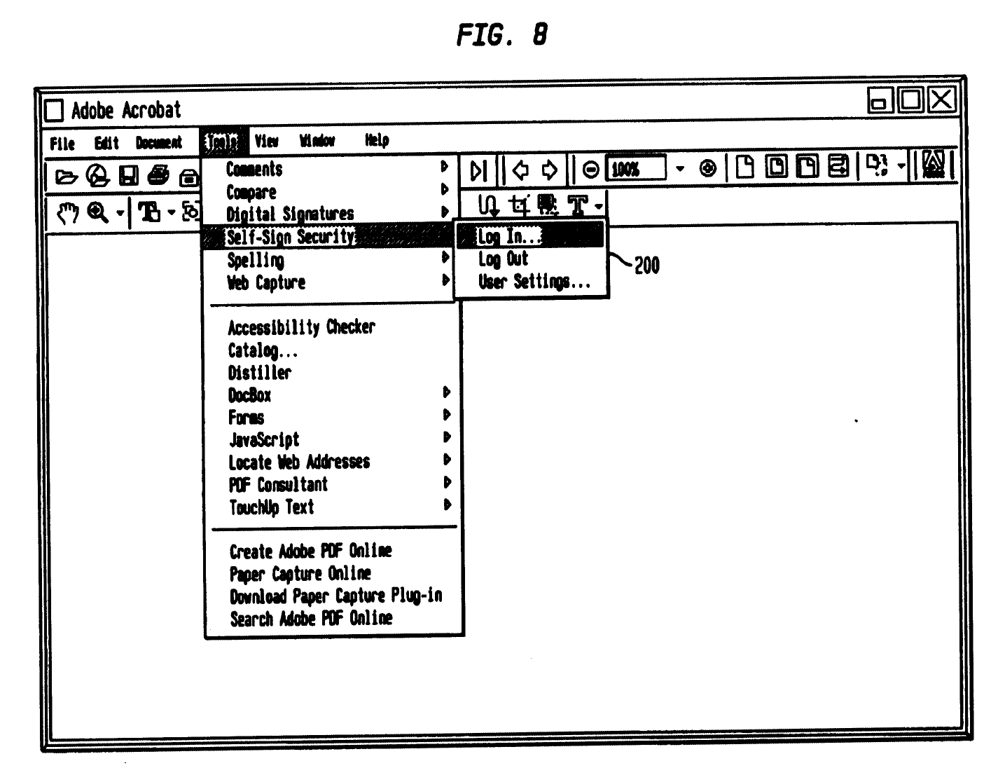

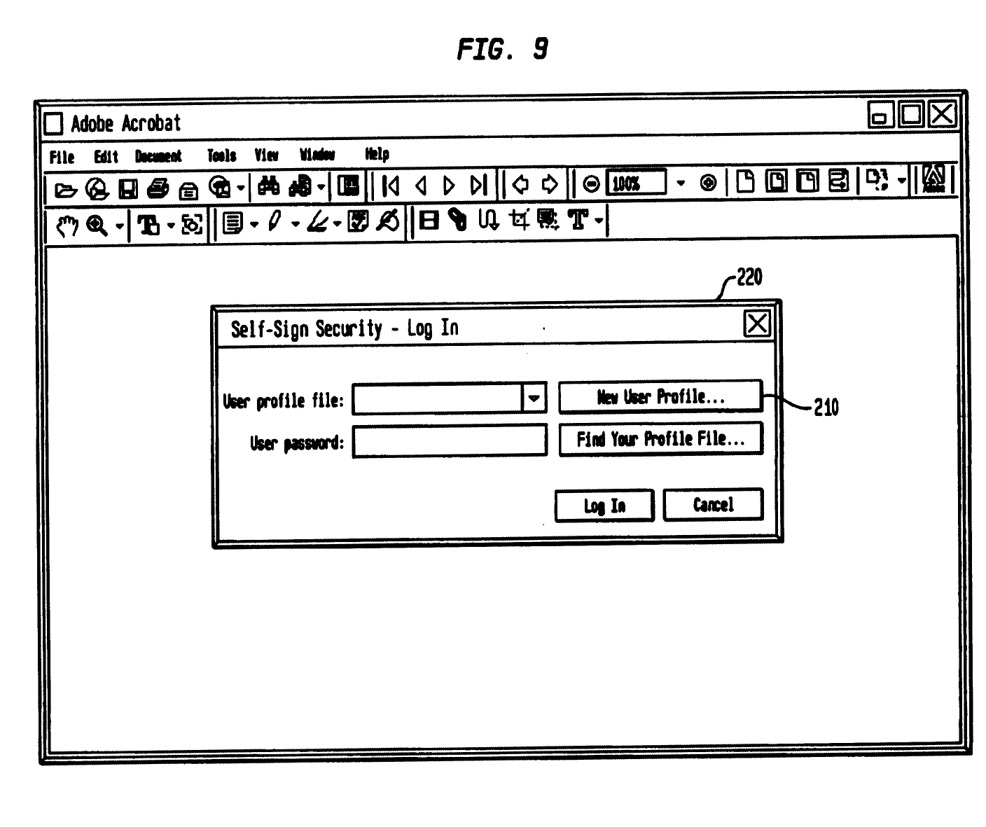

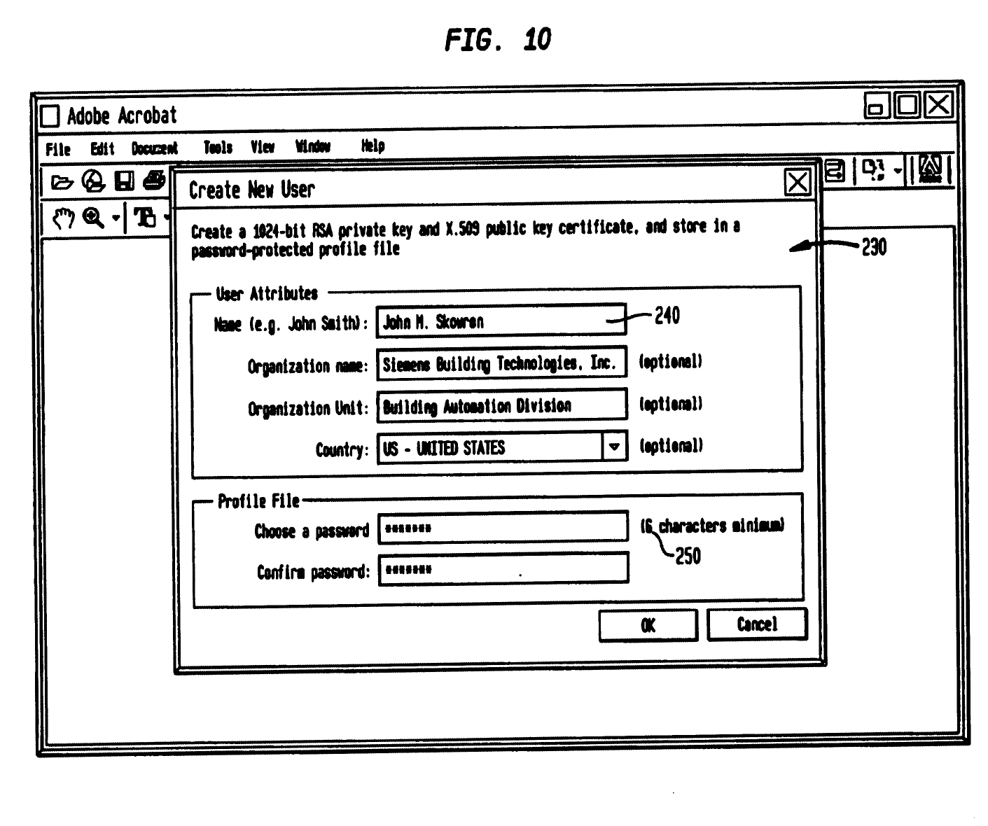

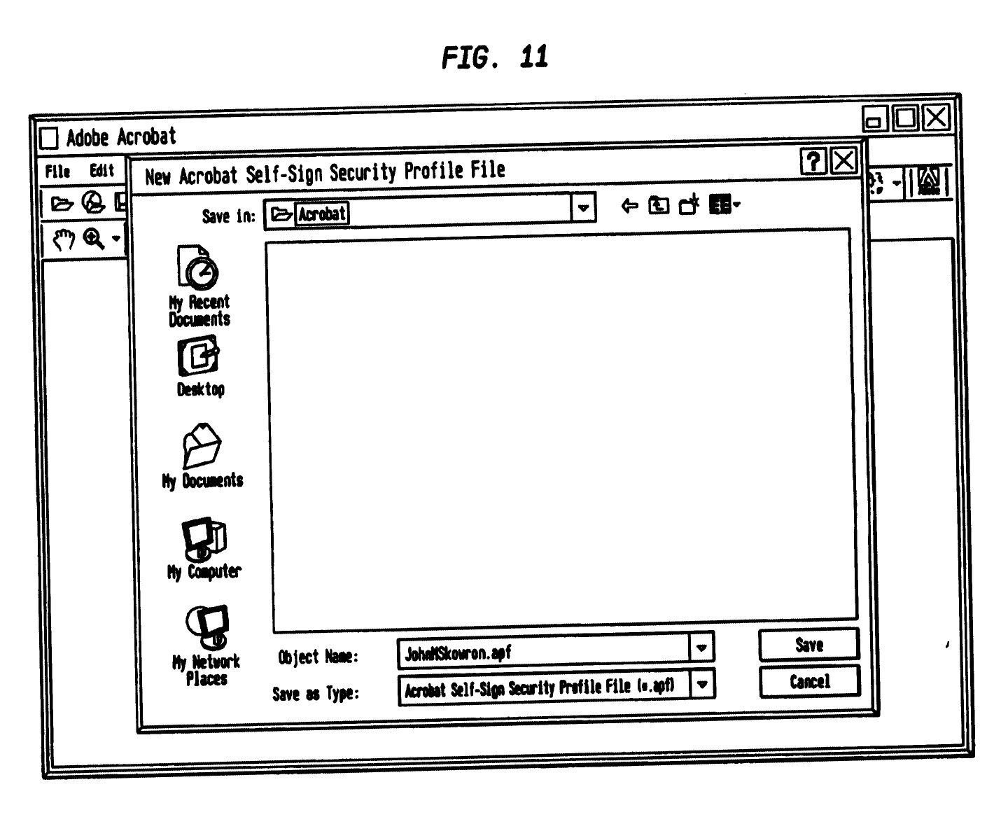

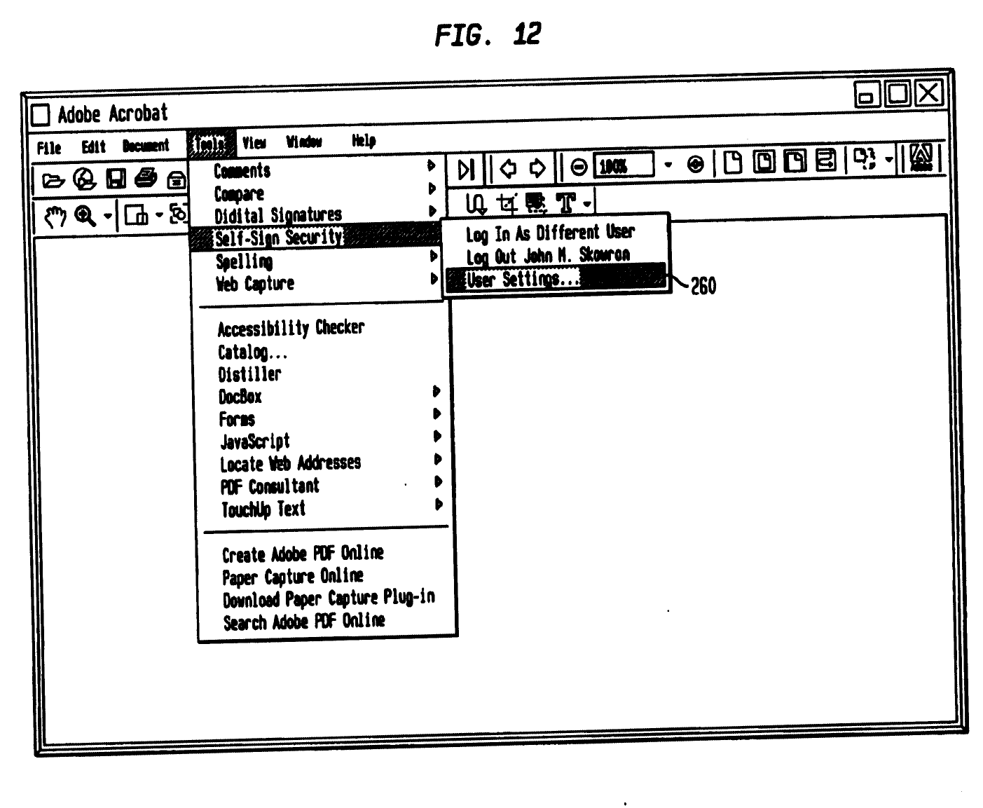

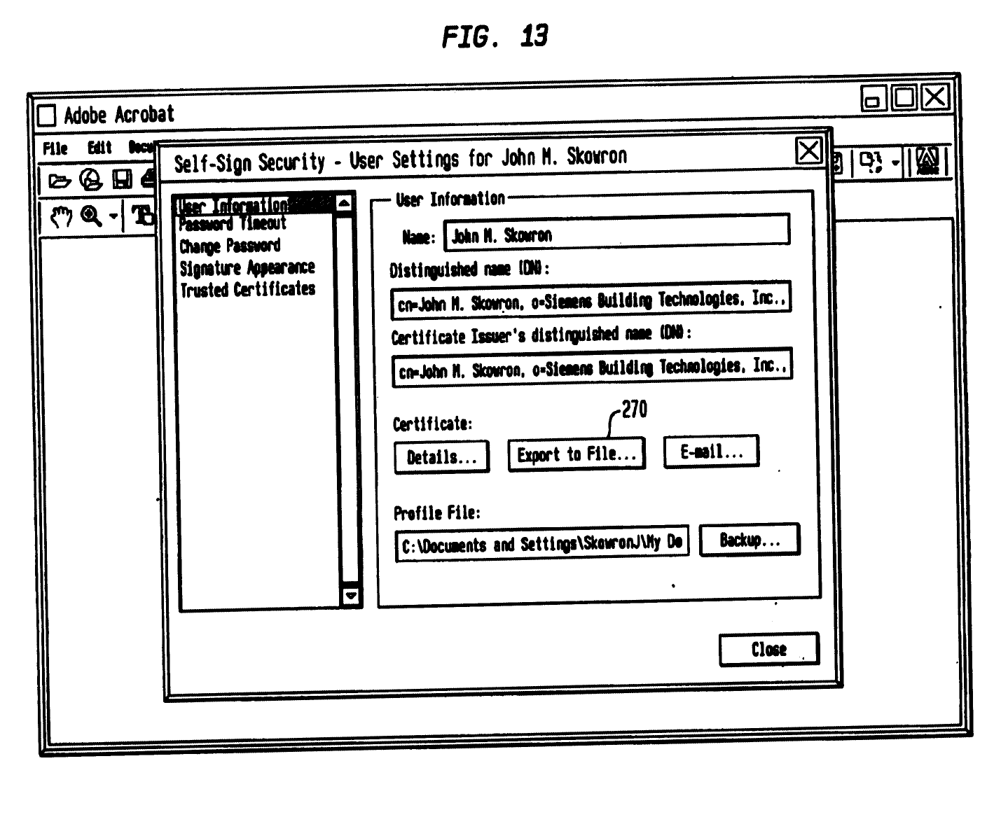

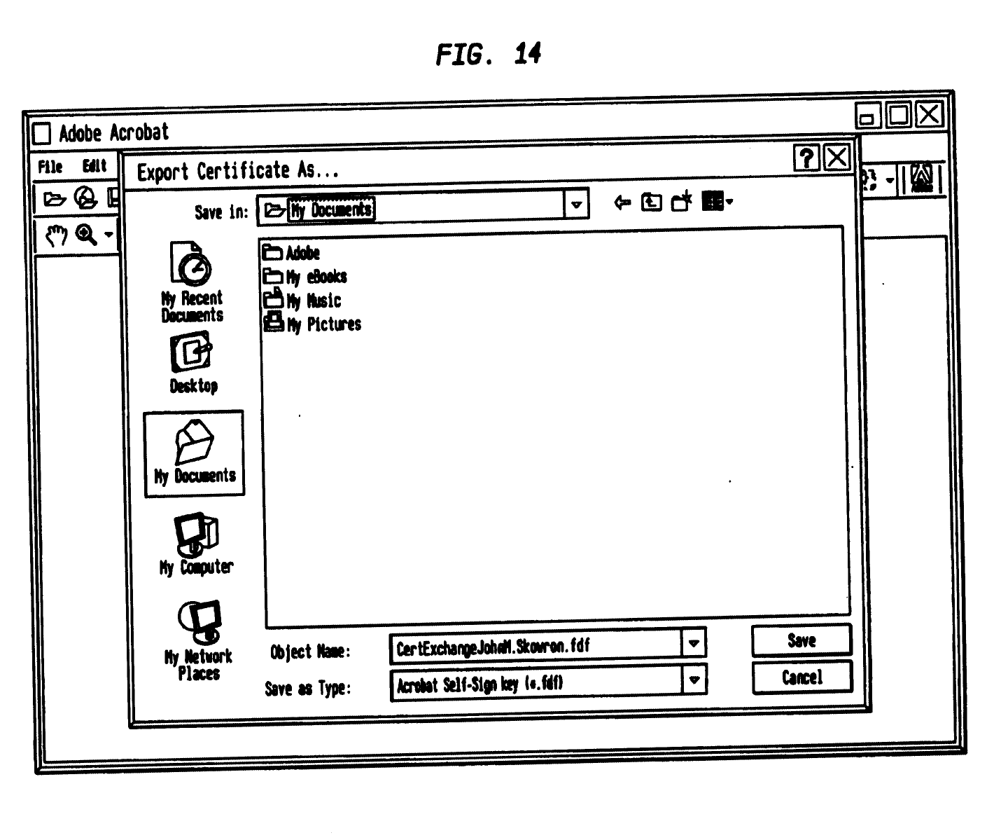

FIG. 8 is an illustration of a screen display for creating a user profile. Screen displays 8-15 and 16-31 are shown on user interface 138 of a client 16. A user may create a profile by starting Adobe Acrobat 137 and choose Tools>Self-Sign Security>Log In 200. As shown in FIG. 9, the user may then select New User Profile 210 in the Self-Sign Security—Log in box 220. As shown in FIG. 10. in the Create New User dialog box 230, the user may enter a name for their user profile in text box 240. When a user adds a signature to a document, this user profile name is the name that appears in the Signatures palette. It is also the name that will appear in the signature field. The user will preferably create a password containing at least six characters. The user will preferably enter the same password in both the User Password and Confirm Password text box 250. As shown in FIG. 11, the user may save their signature in a secure directory. Once a user has created a user profile, the user may then create user settings 260 for their profile, as shown in FIG. 12. The resulting display is shown in FIG. 13. The user may save their certificate in a secure directory by selecting the Export to File button 270. The user may then save their certificate in a secure directory, as shown in FIG. 14. The user may repeat the above steps for all types of signature profiles a user may wish to create. Examples might include a formal signature, initials, and handwritten representation. These profiles can then be used anywhere on a document.

In step 760, final security and access settings can be made. In the present invention, users may not be given access to report manager 135 and any existing reports until their signatures profiles are configured and saved to the secure directory and their full control permissions to that directory have been changed to read-only. A signature may not be applied unless a user has write access. Once this is completed, users can be added to the IM_Report group and allowed to run the report manager.

In step 770, the user certificate contains a public key that is used to verify a digital signature. Before other users can verify a signature on documents they receive, they must have access to the user certificate. This access should be managed and controlled by the signature administrator. Each user will have access to their certificates via a centralized and secure file share. Because the administrator has granted read-only access to these shares, he or she has the original certificates and can verify any signature at a later date based on the original signature profiles. This responsibility can be distributed by giving read access to others' user certificates.

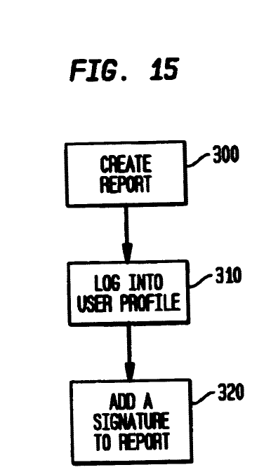

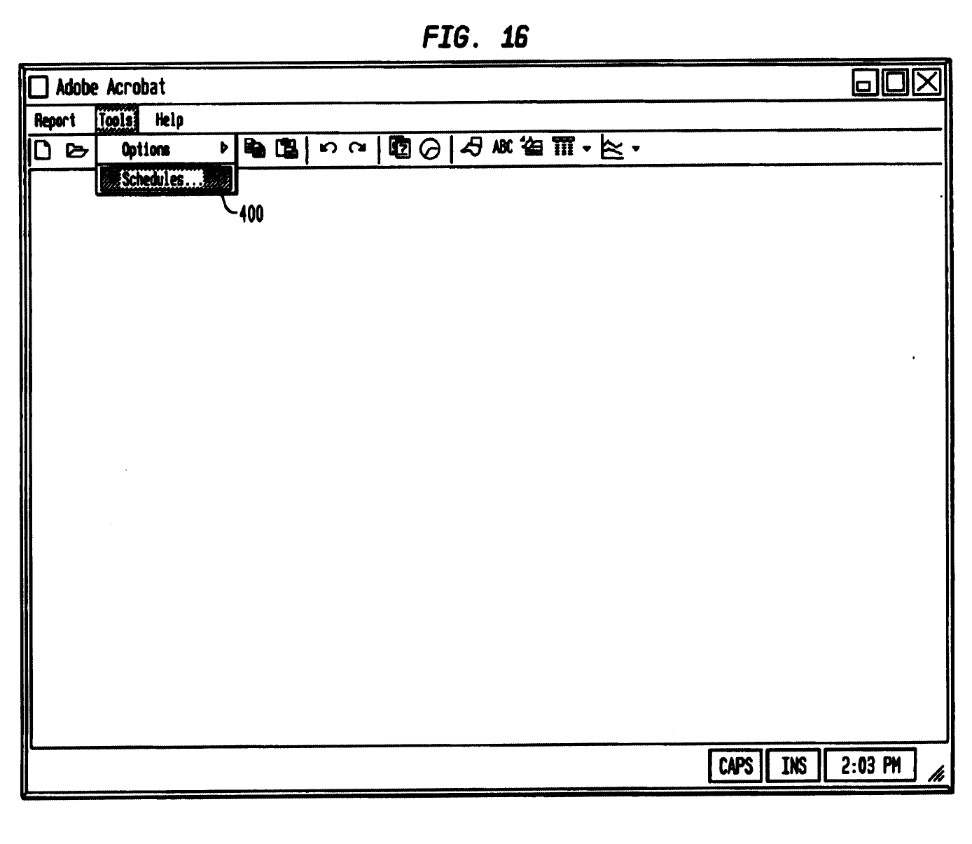

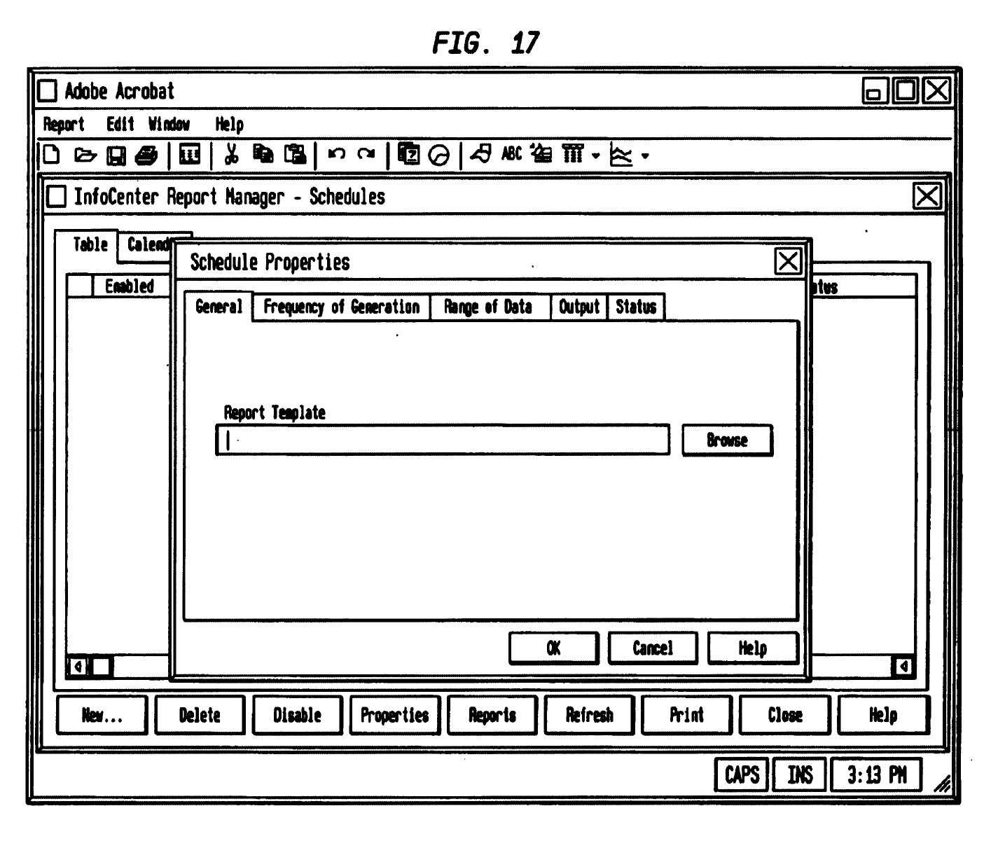

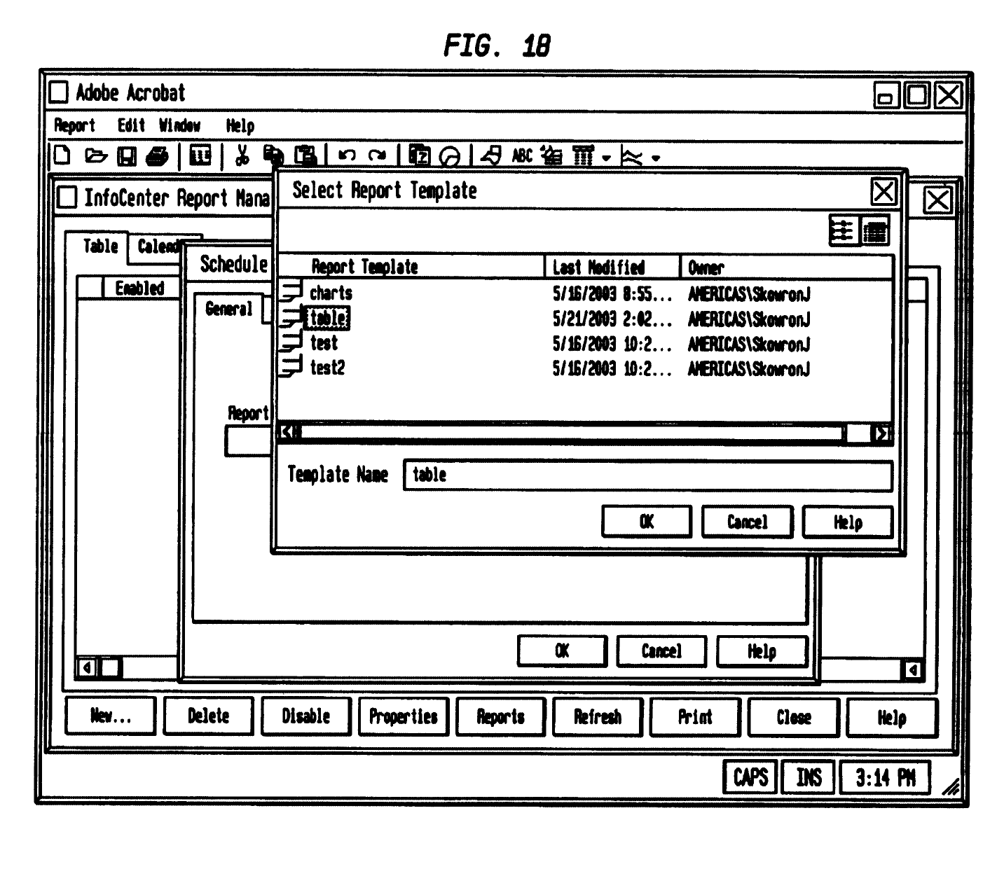

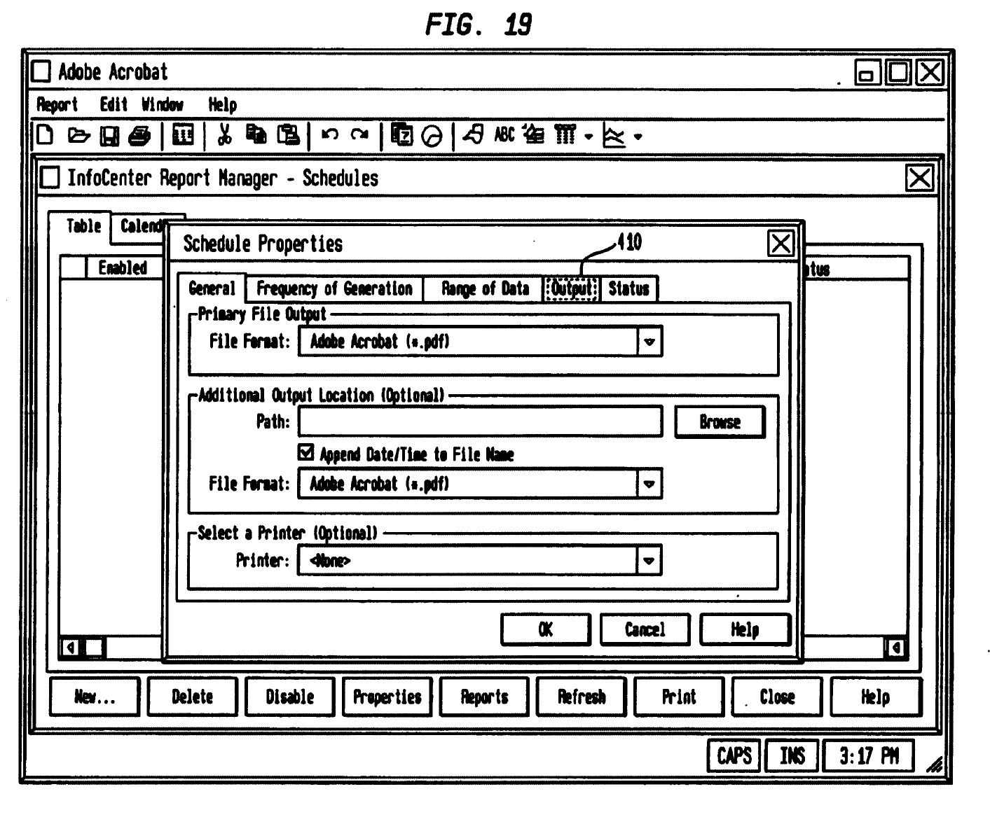

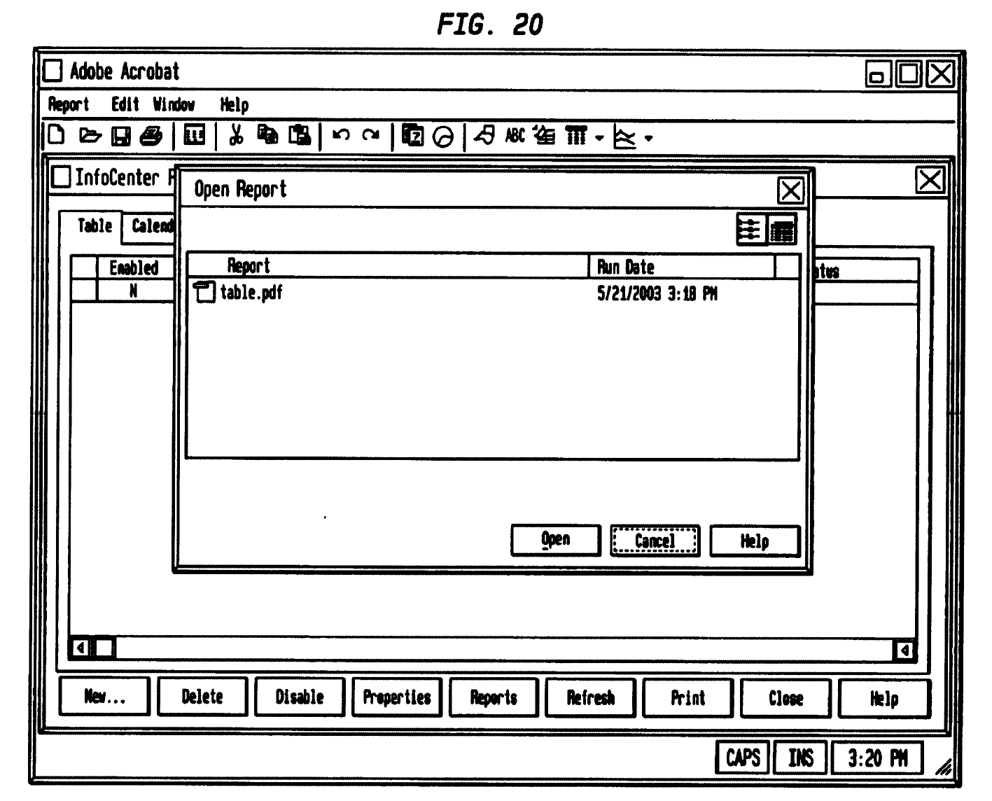

FIG. 15 illustrates the steps involved in creating and signing reports. In step 300, a user can use report manager to create a template, then a schedule, and then the schedule is run to create a report. As shown in FIG. 16, a user can open Tools>Schedules 400 to start the report manager 135. As shown in FIG. 17, the user may schedule a report template. Referring to FIG. 18, a may then select a report template. Referring to FIG. 19, under the Output tab 410, the user may select the Primary File Output File Format as PDF if this is the user's desired format. As shown in FIG. 20, after the report is run, the user may open the report from the schedules window in the report manager.

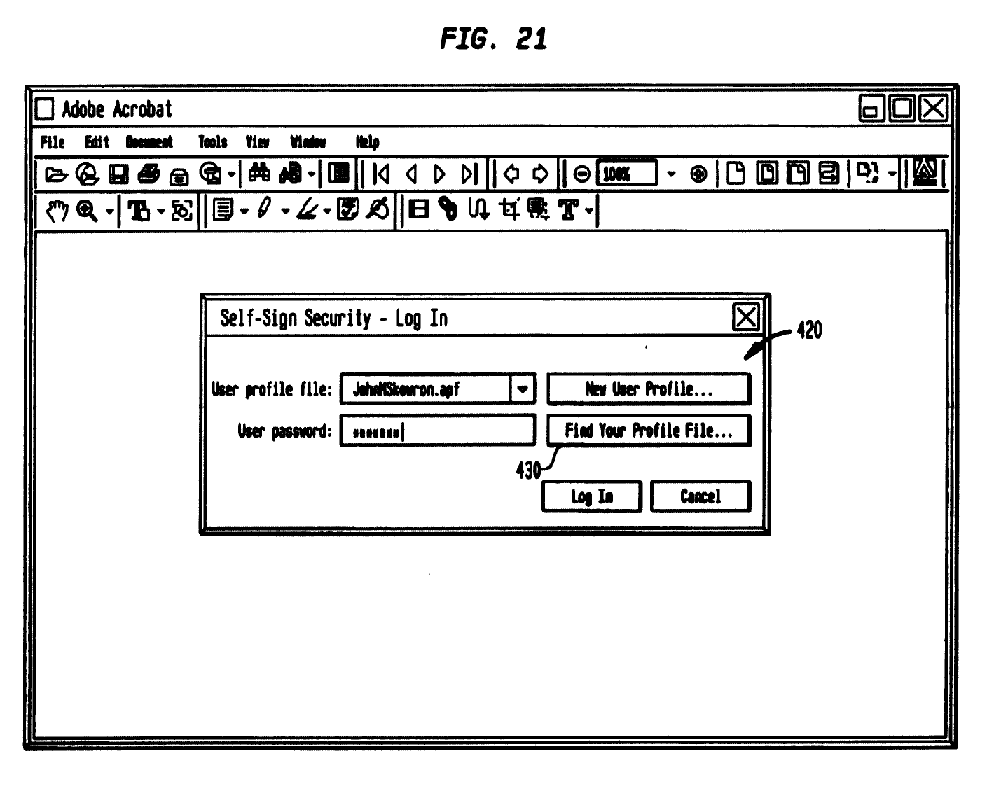

In step 310, a user will need to be logged in to their profile before they can sign documents or verify signatures. When users view a scheduled report, the report manager will automatically open the associated application for this file on the client PC. For PDF reports that are to be signed, this should be Adobe Acrobat. When users open a scheduled Report, they will be able to view it using Adobe Acrobat. Once viewing the report, users can log into their secure signature profile. As shown in FIG. 21, if a user wishes to sign a document using the digital signatures feature or the digital signature tool, they will be prompted to log in to their profile (if they have not already done so) before signing the document. As shown in FIG. 21, the user may select Tools>Self-Sign Security>Log In, and then navigate to the secure directory and select the desired profile.

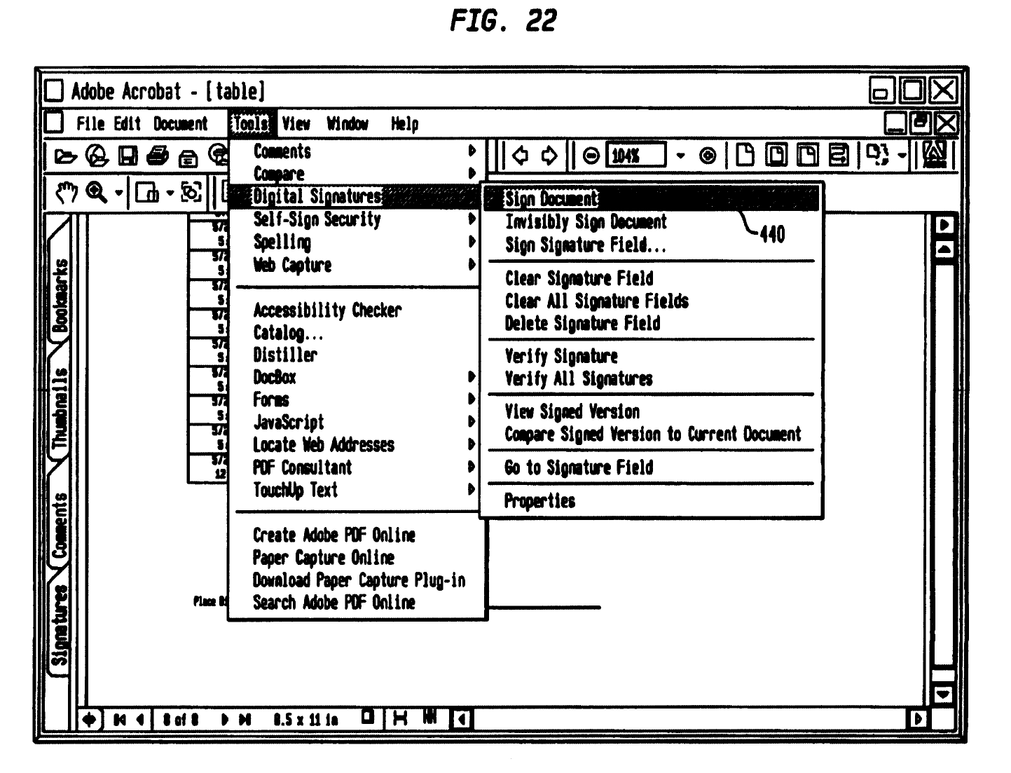

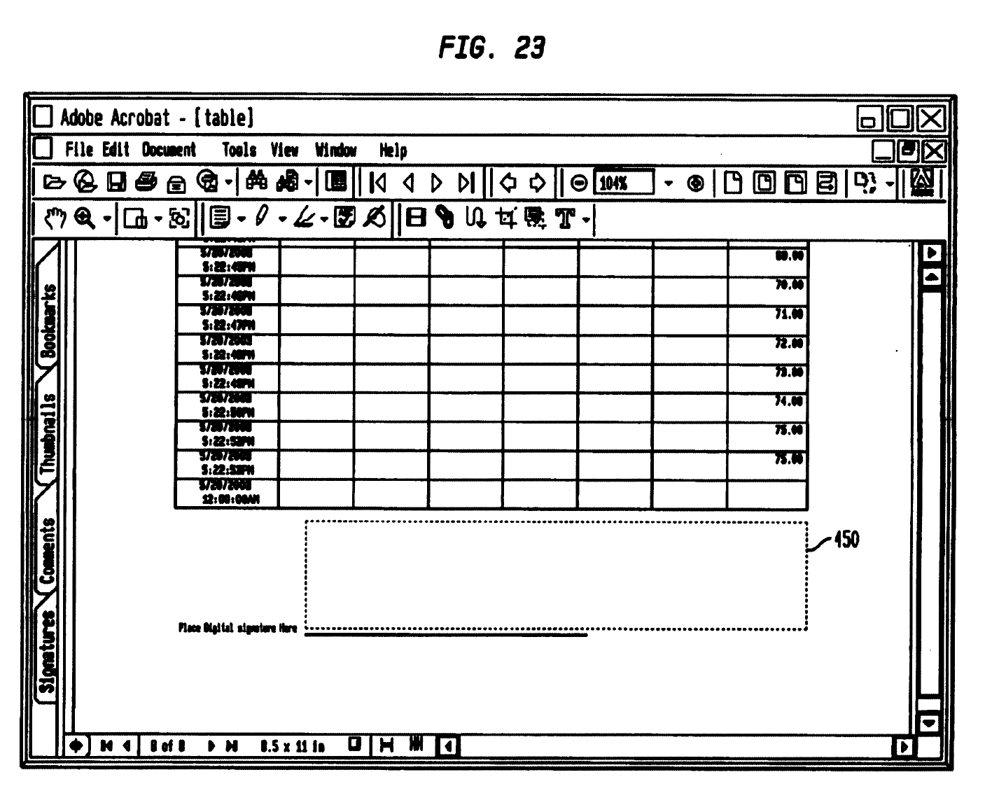

In step 320, the user can add a signature to a report. The user can sign a document in several ways, both visibly and invisibly. Invisible signatures do not appear in the document although they are included. As shown in FIG. 21, to sign a document, if the user is not already logged in to a profile, the user may choose Tools>Self-Sign Security>Log In. In the Log In dialog box 420, the user may choose their profile from the pop-up menu, or click Find Your Profile File 430 and use the browser to find a profile. Then user may then enter their password for the profile. Next, as shown in FIG. 22, the user may select the option of signing a document by selecting sign document 440. As shown in FIG. 23, the user now has the option to digitally authenticate a document. If the user is logged in to a digital signatures profile, the user has several options for signing the document. To fill in an existing signature field, the user may click the unsigned field in the document pane 450, or select the unsigned field in the Signatures palette and choose Sign Signature Field from the Signatures palette menu. The user may right-click the existing signature field in the palette or document, and choose Sign Signature Field from the context menu. The user may chose Tools>Digital Signatures>Sign Document, and click OK. To add a new signature field and sign at the same time, select the signature tool and drag to draw the field. To sign the document invisibly, the user may choose Tools>Digital Signatures>Invisibly Sign Document.

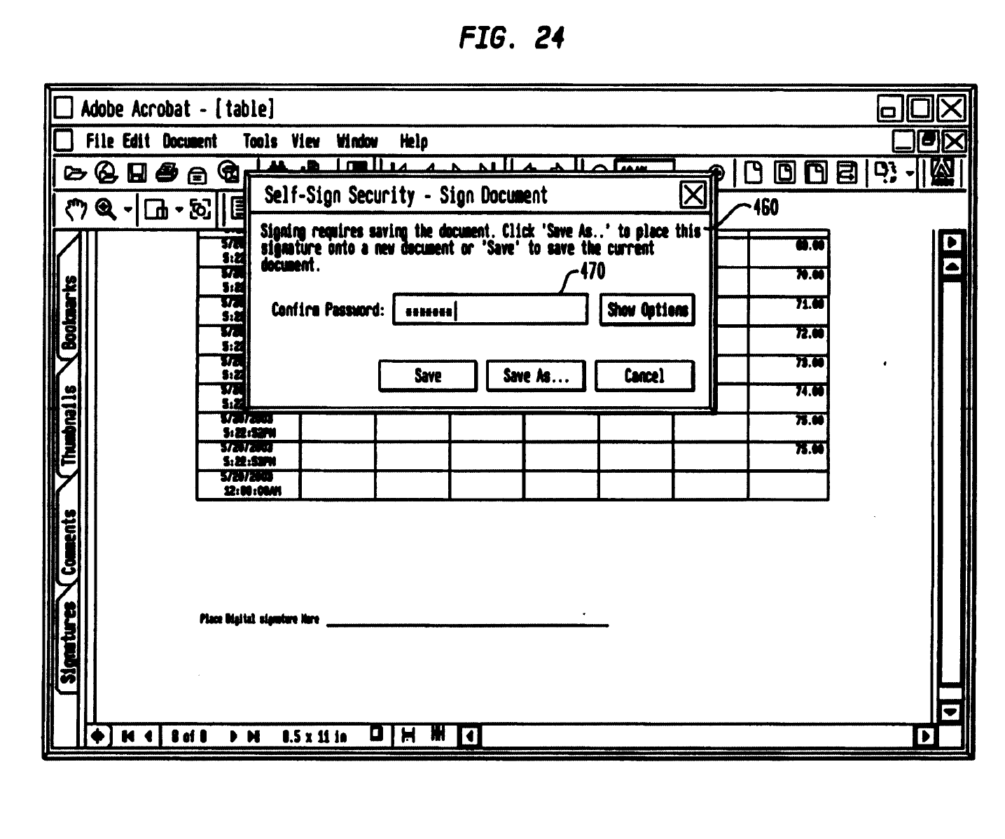

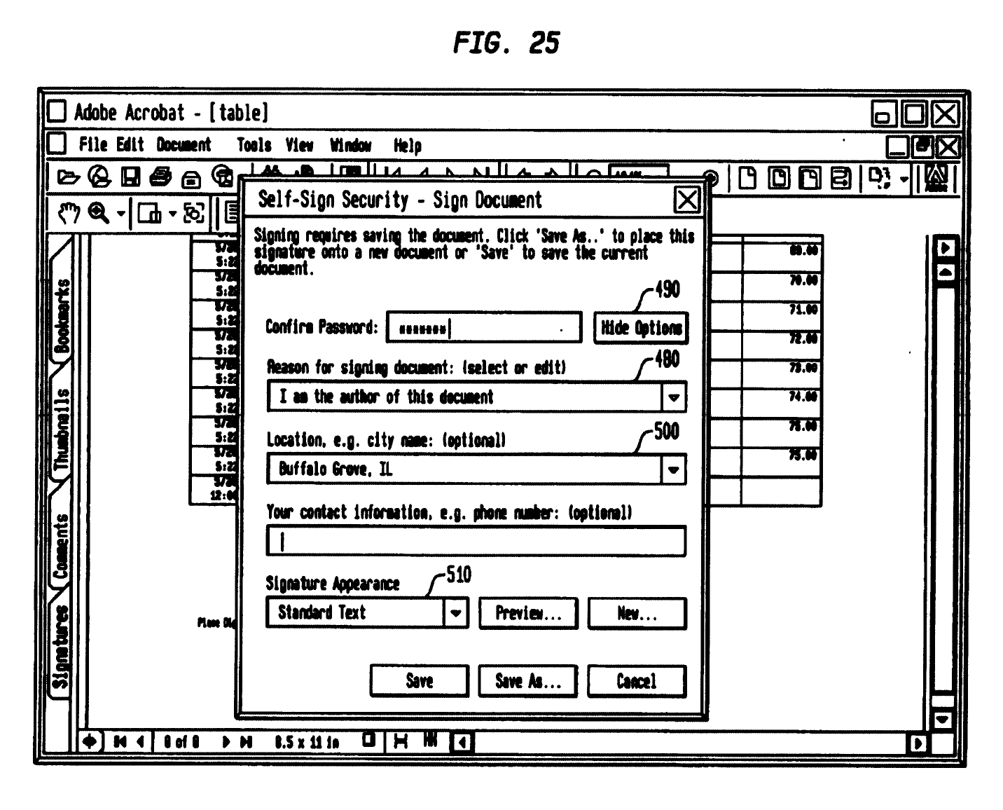

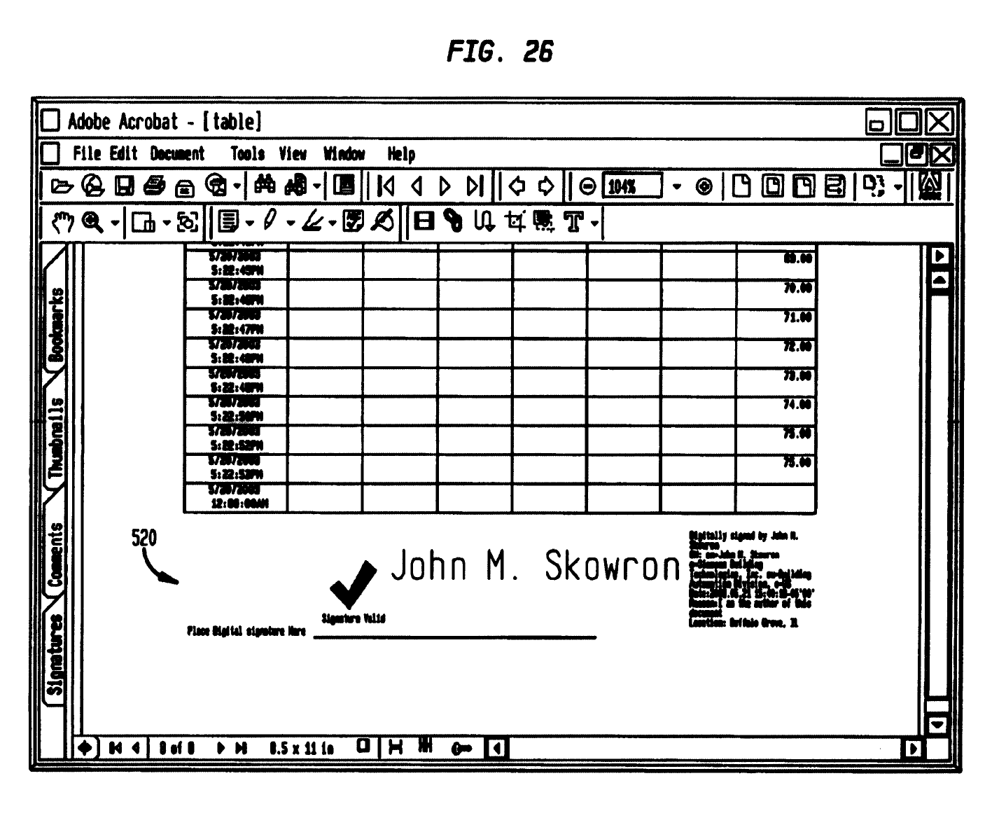

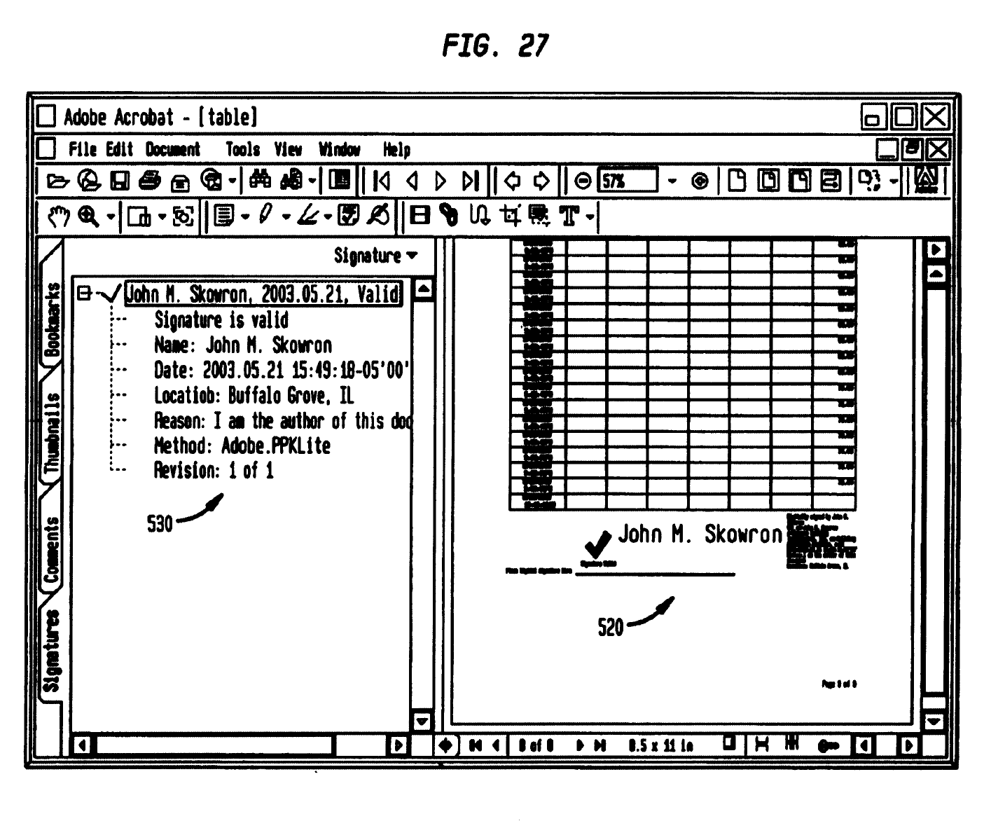

Referring now to FIG. 24, in the Sign Document dialog box 460, the user is then required to enter their password in the Confirm Password text box 470. Turning to FIG. 25 the user has the option of entering a reason for signing the document in area 480 of box 490. The user can either type a reason or choose one from the pop-up menu. Additionally, in area 500 the user can enter a location for the signature, such as the user's city, state, or county, or the hostname of the user's your computer, and you can add contact information for validation purposes. The user may also choose a signature appearance in area 510. Standard Text displays the icon with the distinguished name defined in the profile, the date and time of the signing, and the reason for signing. If the user has defined a personalized signature, the user may choose it from the pop-up menu. As shown in FIG. 26, in area 520 the new signature appears as the last item in the Signatures palette. As shown in FIG. 27, the user has the option of displaying information about the signature 520 in area 530.

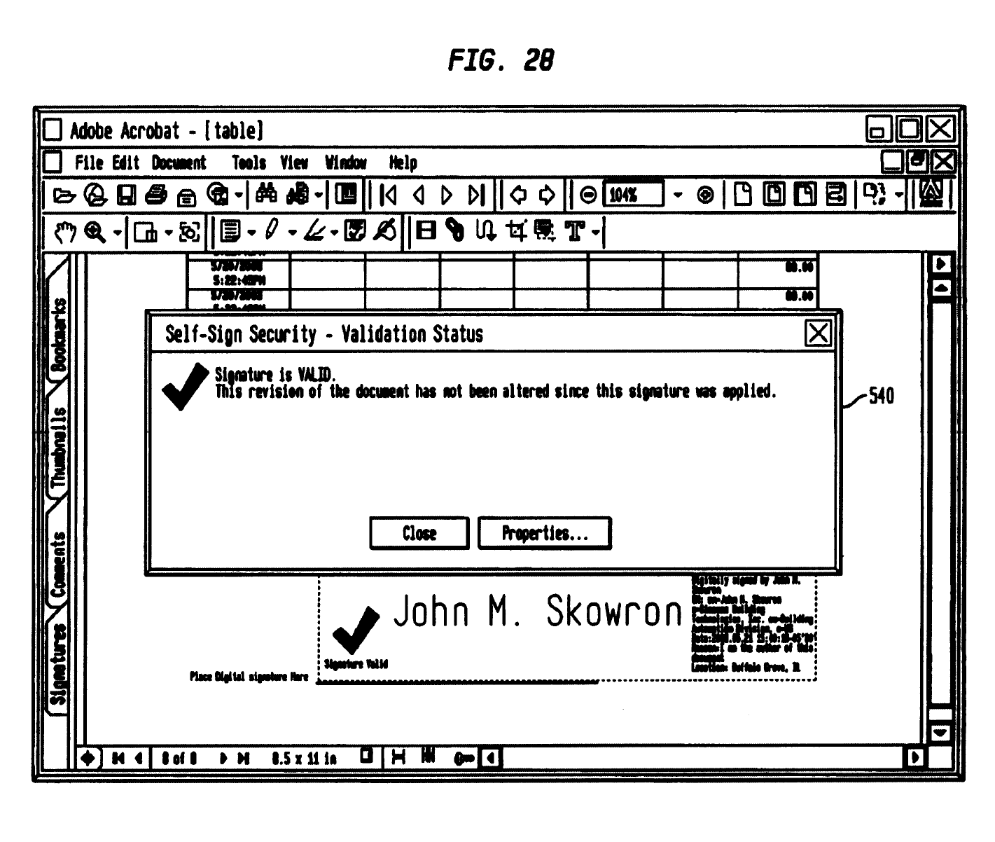

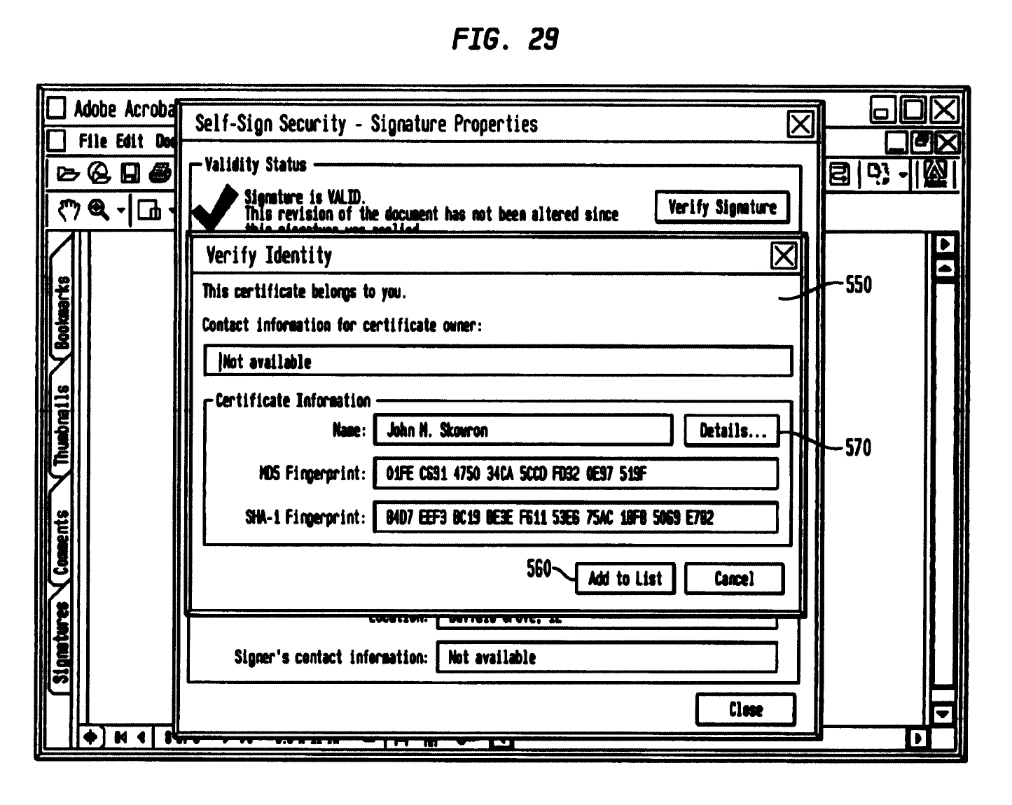

After a report is properly authorized, there are several tools available to validate signatures, track changes, and compare versions of a report. When you verify a signature that was added with Acrobat Self-Sign Security, Acrobat can confirm the authenticity of the signature in two ways. First, Acrobat may be used to check to see that the document and the signature have not been altered since the signing. Second, if the user is logged in to a profile and the user has the signer's user certificate in the user's profile's list of trusted certificates, Acrobat compares information in the signature against the certificate to verify the identity of the signer. The user may view a signature's verification status on the document page and in the Signatures palette. As shown in FIG. 28, to verify a signature in an open document, the user may do one of the following. One way to verify a signature is to click the signature in the document pane. A dialog box 540 indicates the status of the signature. The user may click Properties to access the Signature Properties dialog box. Click Verify Identity to check fingerprint information. The user also has the option to right-click in the signature, and click Validate Signature. In the Validation Status dialog box, on Windows click Identity (if you are logged in) or Log In (if you are not logged in then follow the login process.) Referring to FIG. 29, in the Verify Identity dialog box 550, the user may follow the on-screen instructions for verifying finger-print information. The user may click Add to List 560 when the user is sure that this is a valid user certificate. The user may click Details 570 to see information about the signer. The may then click OK in the Alert dialog box, and click Close in the Validation Status dialog box to verify the signature.

The present invention further provides for the tracking of digital signatures in a signatures palette. The Signatures palette lists all the signatures in the current document (with their status), in the order they were added. The user can collapse a signature to see only a name, date, and status, or the user may expand it to see more information.

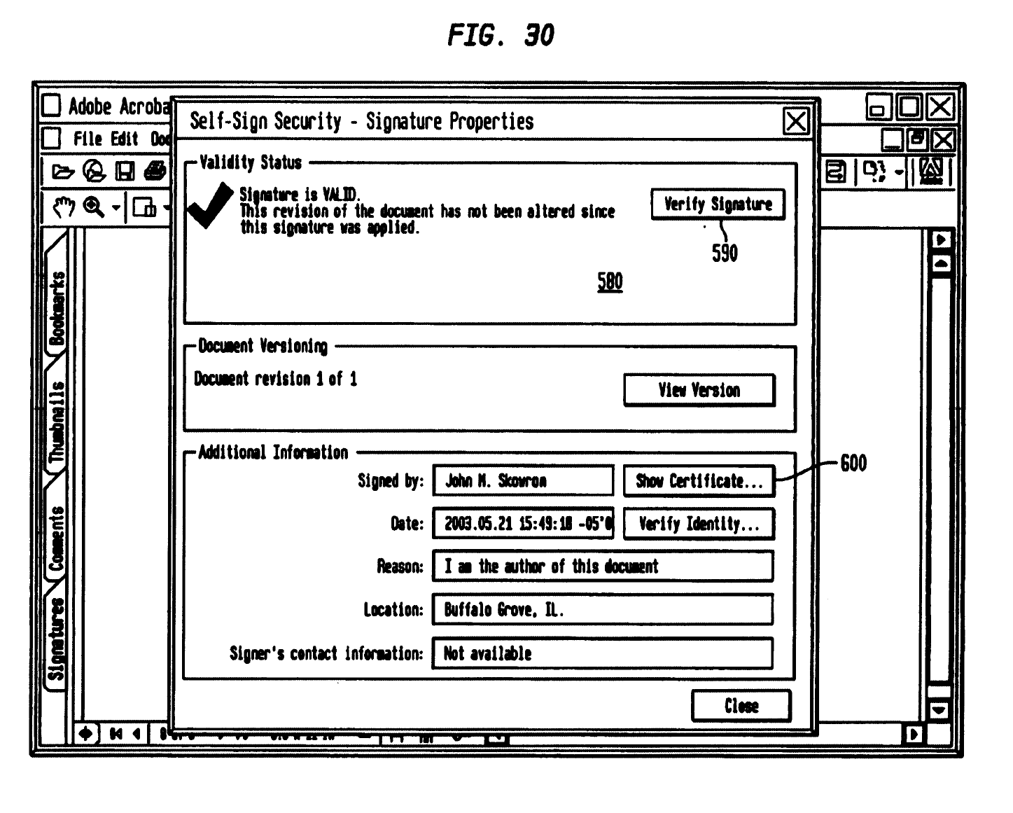

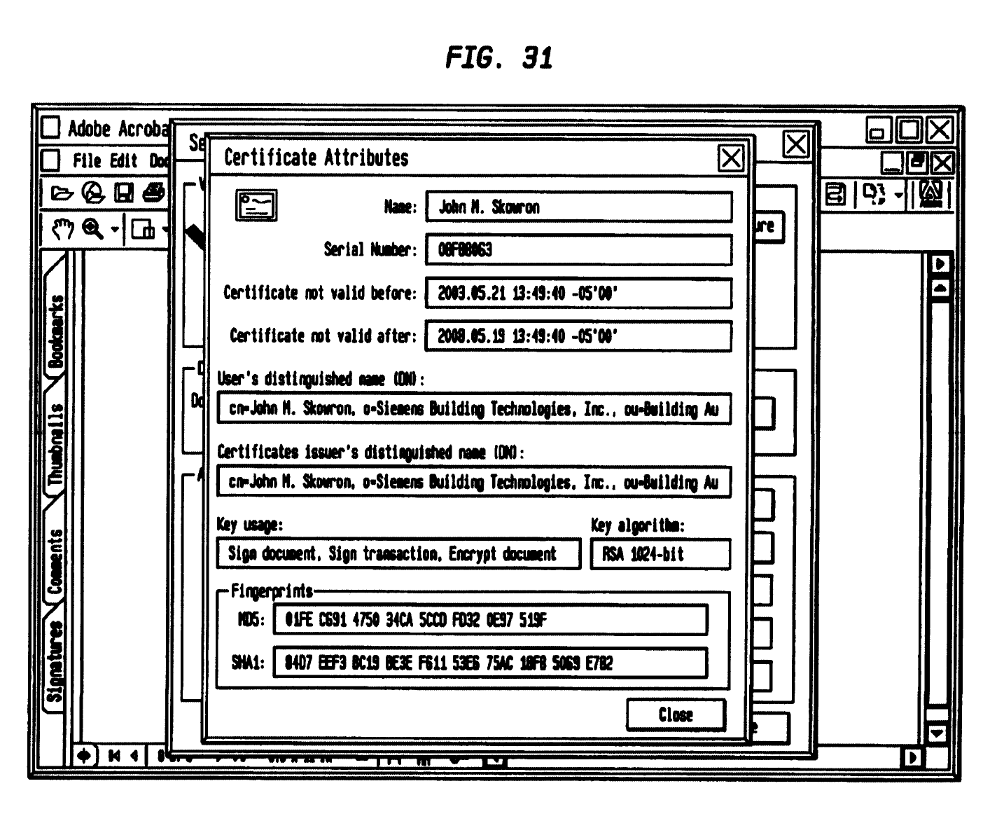

Using the present invention, a user may get information about a signature. The user may open a dialog box to view an explanation of a signature's verification status, the document version the signature applies to, and information such as date and time of the signing. This dialog box is not editable, but you can copy text from it and click buttons to work with the signature. Referring to FIG. 30, to get information on a signature, the user may select a signature in the signatures palette, and choose Properties from the Signatures palette menu or right-click (Windows) the signature in the palette or document pane, and choose Properties from the context menu. In the Signature Properties dialog box 580, the user has the option, to verify a signature, to click Verify Signature 590. This also updates information in the dialog box. The user has another option to click Show Certificate 600, to view user attributes, verification parameters, and other information on the signature's certificate. This button 600 is available only if the signature has been verified. The resulting display is shown in FIG. 31.

If a document is signed more than once, Acrobat maintains all of the signed versions in a single Adobe PDF file. After the first time a document is signed, and each time the document is signed, a version is saved as appendonly to ensure that it will not be altered. All signatures and the versions of the document corresponding to those signatures are listed in the Signatures palette. To open an earlier signed version, the user may select the signature in the Signatures palette, and choose View Signed Version from the Signatures palette menu. The earlier version will open in a new Adobe PDF file, with the version information and the name of the signer in the title bar.

The present invention allows users to compare two versions of a signed document. With the Compare Two Versions Within a Signed Document command, you compare two versions of the same signed document. With this command, changes made at each signature checkpoint are displayed. In the comparison file, each document begins with a summary page that gives the document's filename and the number of pages containing hidden and visual differences, depending on the parameters used in the comparison. Subsequent pages in the file show a side-by-side comparison of the pages that differ, with the differences highlighted. A header on each page identifies the file and the differences found on the page. The differences are highlighted in magenta on the pages.

If any pixels differ on the two pages, the specific differences are highlighted on both pages. For example, a word may have been edited or deleted, or a comment may have been added. The change may also be one that is barely noticeable, such as a slightly different tab stop or a small shift of the page's content to one side. Differences will be highlighted on both pages. If no pixels differ but the PDF information on the pages differs, both pages are entirely highlighted. For example, some PDF marking behind an opaque object may have changed, or the crop box may have changed without any additional cropping being obvious. If a page has been added, it is paired with a new blank page. If a page has been deleted, it is represented by a blank page and paired with its corresponding page in the other document.

The highlighted differences are stored as pencil comments in the comparison file. A user can use the Comments palette to see a list of all the differences, and the user can double-click a difference in the palette to go to that place on a page. The side-by-side display of pages in comparison files is designed for two-up printing.

To get information on certificates, users can open a dialog box to view user attributes, verification parameters, and other information on a particular certificate. The dialog box is not editable, but you can copy text from it. Users must be granted access to other certificates to view this information. The distinguished name (DN) is the name, organization, and country that the user provided when they created the profile. In Acrobat Self-Sign Security, the user DN and the certificate issuer DN are the same because a certificate is always issued by the user rather than by a third-party authority.

The fingerprint information can be compared for two users when importing a certificate to make sure the certificate came from the user it represents. The serial number is a unique number that ensures no two certificates from the same DN can be identical. The validation period specifies a span of time in which the certificate is valid. It begins with the date and time the certificate was created.

The system administrator should periodically retrieve a copy of all secure certificates from the share files and build a list of trusted certificates to verify any electronic signatures when required. This is done by adding the certificates to a list of trusted certificates by importing the certificate from an Acrobat key file located in secure user shares.

By the time a user gets to the point of inserting a signature into a report manager 135 report, the system has validated their identity using combinations of their password and userID five times. This rigorous security is as follows. To sign a report a user must have access to run report manager. The system uses the user's userID and password compared to an access list to grant access to the application. Windows integrated security uses the Windows credentials of the workstation, so this process happens automatically. If a user wants to explicitly be prompted for this information when launching the report manager for a signing session, they should ask the system administrator to define an account for them that is not the same as their client workstation Windows account. After access to Report Manager 135 is granted, the server 12 uses the user's Windows account credentials to grant access to only those reports the user has rights to view. During the review of a report in the report manager-spawned Adobe Acrobat, a user must first log into their profile to perform signature functions. Because this profile is in the secure signature share, the password and username were required to gain access to the profile. Once access to the share is granted, the user must explicitly enter a password to log into the profile. Each time a signature is actually inserted on the report, the user must again enter the password for the signature profile.

The ability to verify signatures as authentic is controlled by the secure signature share. It is only these certificates that can be used to validate/verify a signature. If a document contains a signature that is not legitimate, a verification check on the report will show the signature is not valid. The order of signings and other information are contained in the Signature palette of Adobe Acrobat.

In the present invention, NTFS security is used for the signature share since NTFS allows administrators to control access to files and directories. This security allows the digital certificates in those locations to be controlled and protected.

In the present invention, auditing may be configured on the signature share since auditing allows administrators to detect unauthorized access to files or folders in the share. This way, a log will be generated if users try to access someone else's signature files. A scheduled review of the Windows security logs will support needs to detect unauthorized access. Third-party software is also available to monitor the securities logs of Windows and proactively communicate these instances to the proper officials.

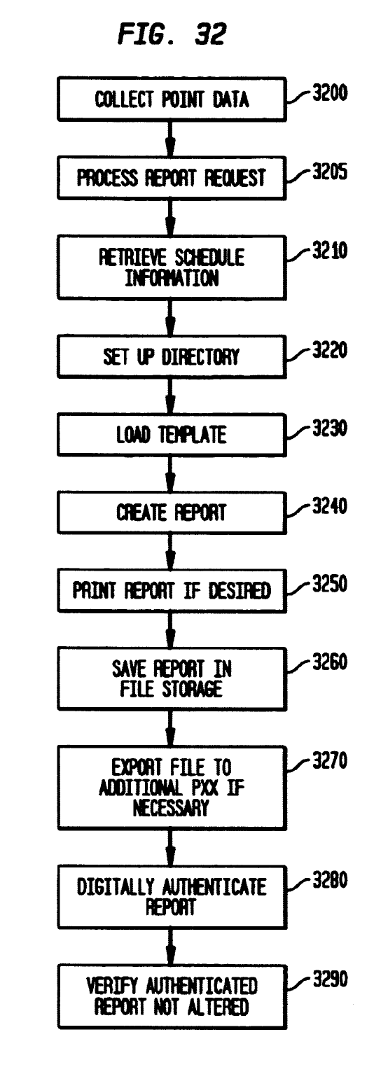

Referring now to FIG. 32, an overview of the present invention is provided. As shown in step 3200, point data from one or more points may be stored in database 100 of server 12. In step 3205, the present invention may process a report request from report manager 135 of a client 16. In step 3210, the schedule information is retrieved from database 100. As shown in step 3220, a specific directory for the current user schedule is set up. As shown in step 3230, a template and its controls are set up. As shown in step 3240, template information, point data, and the desired format of a report, preferably PDF, is provided to the report generator 80 and the report generator 80 creates a report. As shown in step 3250, the user may print the report generated by the report generator 80 if desired. As shown in step 3260, the report generated by the report generator 80 may be stored in file storage 85. In step 3270, the file may be exported to an additional path if necessary. In step 3280, a user using software 137 may then digitally authenticate the report. In step 3290, software 137 may be used to determine if a digitally authenticated report has been altered.

It will be appreciated by those skilled in the art that the present invention can be embodied in other specific forms without departing from the spirit or essential characteristics thereof. The presently disclosed embodiments are therefore considered in all respects to be illustrative and not restricted.

We claim:

1) A method for digitally authenticating a report generated for a facility comprising:
providing a plurality of points;
providing a facility management system for monitoring the conditions in a facility;
enabling data communication between said facility management system and each of said points, wherein each of said points provides data about the conditions in a facility;
transmitting said data from said points to said facility management system,
providing an information server comprised of a database;
transmitting said data from said facility management system to said information server and storing said data in said database;
providing a plurality of clients operatively connected to said information server;
generating one or more reports from said data in said database;
displaying a report on a client;
receiving a user request to digitally authenticate said report;
digitally authenticating said report; and
storing said digitally authenticated report on said server.

2) The method according to claim 1, wherein the report generated for the client comprises a summary of information about information collected from a point for a predetermined period of time.

3) The method according to claim 1, wherein the report generated comprises data collected after a point detects a predetermined condition.

4) The method according to claim 1, wherein reports are comprised of tables, charts, objects and data.

5) The method according to claim 1, further comprising providing a log of user access attempts to a digitally authorized signature.

6) The method according to claim 1, further comprising storing an audit trail of changes to a digitally authorized signature.

7) The method according to claim 1, further comprising storing different versions of a digitally authenticated report and allowing users to view the originally signed version of a digitally authenticated report after the report has been altered.

8) The method according to claim 1, further comprising highlighting changes to a report after a report has been digitally authenticated.

9) The method according to claim 1, further comprising verifying a digital signature to determine if the signature is authentic.

10) The method according to claim 1, further comprising displaying different versions of a report side by side.

11) The method according to claim 10, further comprising highlighting differences between displayed reports.

12) The method according to claim 7, further comprising comparing pixels between two versions of a document and highlighting specific differences on both reports.

13) The method according to claim 7, further comprising comparing versions of a document and both reports when PDF information on pages differ.

14) The method according to claim 1, further comprising indicating when a digitally authorized report has been signed.

15) The method according to claim 10, wherein said report comprises trend data.

16) The method according to claim 13, wherein said report contains information collected after the detection by a sensor of a predetermined condition.

17) The method according to claim 1, further comprising generating said report in a PDF format.

18) The method according to claim 1, further comprising generating said report in an HTML format.

19) A system for generating reports about the conditions in a facility comprising:
a plurality of points provided in a facility for determining conditions in a facility, wherein each said point is operatively connected to a facility management system, said facility management system capable of acquiring information from said points about the conditions in said facility,
a server operatively connected to said facility management system, said server comprising a database for storing said information acquired by said server from said facility management system;
one or more clients operatively connected to said server, wherein said one or more clients are provided with software for generating reports from said information stored in said database and for digitally authorizing said reports on said client, wherein each said report is comprised of said information received from said one or more sensors about conditions in said facility.

20) The system according to claim 19 wherein said facility management system comprises:
A management level network comprised of at least one server
A building level network operatively connected to said management level network, said building level network comprised of at least one controller
A floor level network operatively connected to said building level network, said floor level network comprised of at least one device to be controlled by said at least one controller, wherein said reports are comprised of data received by said server from said devices.

21) The system according to claim 19, wherein said reports are comprised of data collected after one or more devices detects a predetermined event.

22) The system according to claim 19, wherein said server is capable of determining whether a digitally authenticated report has be altered.
